(19) United States
(12) Patent Application Publication
(10) Pub. No.: US 2026/0019733 A1
(43) Pub. Date: Jan. 15, 2026

(54) WIRELESS CHARGING FOR WEARABLE AUDIO PLAYBACK DEVICES

(71) Applicant: Sonos, Inc., Goleta, CA (US)

(72) Inventors: Joern Riemer, Trabuco Canyon, CA (US); Chadwick Souza, Provience, RI (US); Carla Nicole Pinzon, Boston, MA (US); Kingston Yu, Boston, MA (US)

(21) Appl. No.: 19/248,921

(22) Filed: Jun. 25, 2025

Related U.S. Application Data
(60) Provisional application No. 63/670,508, filed on Jul. 12, 2024.

(51) Int. Cl. H04R 1/10; H04R 1/06

(52) U.S. Cl. CPC H04R 1/1025; H04R 1/06; H04R 1/1008; H04R 1/105; H04R 1/1066; H04R 2420/07

(57) ABSTRACT

Systems and methods for wirelessly powering wearable audio playback devices are disclosed. Such a system can include a wearable audio playback device including a first earcup carrying a first audio transducer and a second earcup carrying a second audio transducer, the first earcup and the second earcup coupled together via a headband, an ear cushion configured to be removably coupled to the first earcup, and a wireless power receiver disposed within the ear cushion. A separate wireless charging device includes an energy storage component and a wireless power transmitter configured to wirelessly supply energy to the wireless power receiver.

### CROSS-REFERENCE TO RELATED APPLICATION

This application claims the benefit of priority to U.S. Patent Application No. 63/670,508, filed Jul. 12, 2024, which is incorporated herein by reference in its entirety.

### FIELD OF THE DISCLOSURE

The present disclosure is related to consumer goods and, more particularly, to methods, systems, products, features, services, and other elements directed to power harvesting and/or distribution involving media playback devices some aspect thereof.

### BACKGROUND

Options for accessing and listening to digital audio in an out-loud setting were limited until in 2002, when SONOS, Inc. began development of a new type of playback system. Sonos then filed one of its first patent applications in 2003, entitled “Method for Synchronizing Audio Playback between Multiple Networked Devices,” and began offering its first media playback systems for sale in 2005. The Sonos Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A shows a partial cutaway view of an environment having a media playback system configured in accordance with aspects of the disclosed technology.

FIG. 1B shows a schematic diagram of the media playback system of FIG. 1A and one or more networks.

FIG. 1C shows a block diagram of a playback device.

FIG. 1D shows a block diagram of a playback device.

FIG. 1E shows a block diagram of a network microphone device.

FIG. 1F shows a block diagram of a network microphone device.

FIG. 1G shows a block diagram of a playback device.

FIG. 1H shows a partially schematic diagram of a control device.

FIGS. 1I through 1L show schematic diagrams of corresponding media playback system zones.

FIG. 1M shows a schematic diagram of media playback system areas.

FIG. 2 is a schematic illustration of a wireless power device and a wearable playback device in accordance with examples of the present technology.

FIG. 3A is a schematic illustration of a wearable playback device with wireless power transfer components in accordance with examples of the present technology.

FIG. 3B is a front view of an example wearable playback device.

FIG. 3C is a perspective view of the wearable playback device of FIG. 3B with the ear cushions separated from the earcups.

FIG. 4 is a front view of an example wearable playback device with one ear cushion separated from its earcup in accordance with aspects of the present technology.

FIG. 5 is a front view of another example wearable playback device with one ear cushion separated from its earcup in accordance with aspects of the present technology.

FIG. 6 is a front view of an ear cushion with wireless transfer components in accordance with examples of the present technology.

FIG. 7 is a perspective view of a wearable playback device in the form of an extended reality device in accordance with examples of the present technology.

FIG. 8 is a front view of a wearable playback device disposed within a charging case in accordance with examples of the present technology.

FIG. 9 is a perspective view of a wearable playback device disposed on a charging stand in accordance with examples of the present technology.

FIG. 10 a perspective view of a wearable playback device disposed on a charging stand in accordance with examples of the present technology.

FIG. 11 is a perspective view of data and power communication between a stationary playback device and a wearable playback device in accordance with examples of the present technology.

FIG. 12 illustrates a method in accordance with examples of the present technology.

The drawings are for the purpose of illustrating example embodiments, but those of ordinary skill in the art will understand that the technology disclosed herein is not limited to the arrangements and/or instrumentality shown in the drawings.

### DETAILED DESCRIPTION

### I. Overview

Wearable audio playback devices, such as headphones, have become increasingly popular due to their convenience and portability. However, as the functionality and features of these devices have expanded, so has their power consumption, necessitating frequent recharging of their internal batteries. Conventionally, wearable playback devices are charged using a wired connection, requiring users to manually connect a wired charging cable each time the device needs recharging. While some attempts have been made to incorporate wireless charging capabilities into wearable playback devices, these solutions often require significant modifications to the device's structure, and take up valuable space for the required electrical components, which can negatively impact the device's aesthetics, comfort, and portability.

The present technology addresses these and other challenges by seamlessly integrating a wireless charging system into the design of a wearable audio playback device. This can allow users to easily recharge a wearable playback device by engaging the playback device with a wireless charger, such as by placing the wearable playback device in a charging case, on a charging stand or pad, or other suitable engagement with a wireless charging device.

In some implementations, at least some of the wireless charging components can be disposed in select locations within the wearable playback device to efficiently utilize the available space. For instance, a wireless power receiver component (e.g., a charging coil) can be disposed within an ear cushion of a headphone device. When the ear cushion is engaged with its corresponding earcup, the wireless power receiver component can be electrically coupled to internal electronics within the earcup, such as power regulation circuitry and other components. When charging the device, the wireless power receiver component can be placed in a suitable position to receive wireless power from an external wireless power device. For instance, a wireless power receiver coil within the ear cushion can be aligned with, and in close proximity to, a wireless power transmitter coil of an external wireless power device, such as charging case, charging stand, or charging pad. Additionally or alternatively, wireless power receiver components (e.g., a charging coil) can be integrated within the headband of a wearable playback device, or at any other suitable location. The wireless power received via the wireless power receiver components can then be used to recharge an on-board battery (or other energy storage device) of the wearable playback device or to power other operations of the device.

By incorporating a wireless power receiver into the ear cushion or headband of a wearable playback device, the present technology enables convenient and efficient charging of the device's battery without compromising its form factor or functionality. This approach allows for increased flexibility in the placement of wireless charging components, enabling larger audio transducers, batteries, and other components with potentially large footprints to be used for improved performance. Additionally, the use of user-replaceable ear cushions containing the wireless power receiver enhances the device's repairability and maintainability. Additionally, the wireless charging device, which can be a case or stand designed to receive the wearable playback device, ensures proper alignment of the wireless power transmitter and receiver for optimal charging efficiency.

While some examples described herein may refer to functions performed by given actors such as “users,” “listeners,” and/or other entities, it should be understood that this is for purposes of explanation only. The claims should not be interpreted to require action by any such example actor unless explicitly required by the language of the claims themselves.

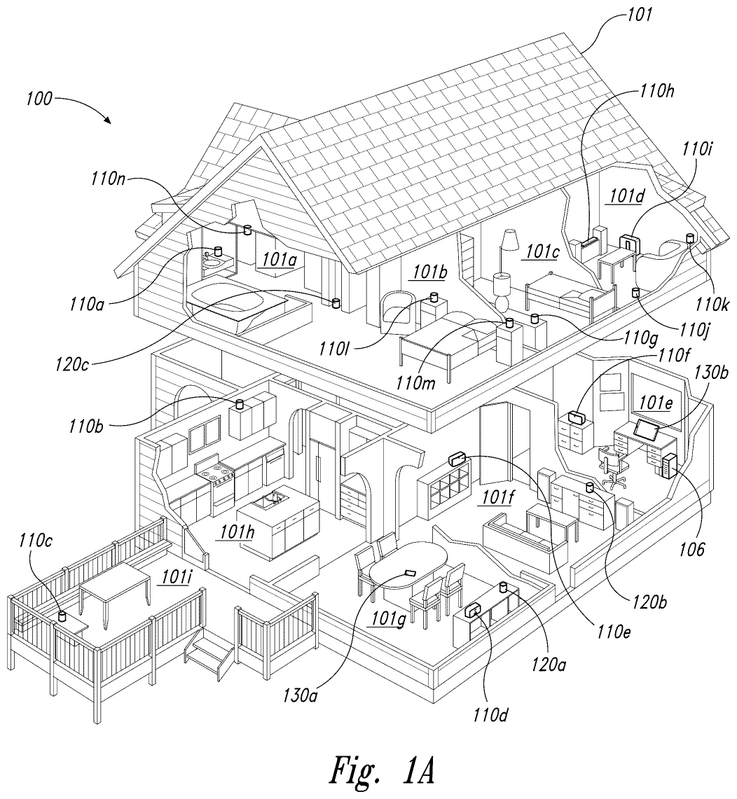

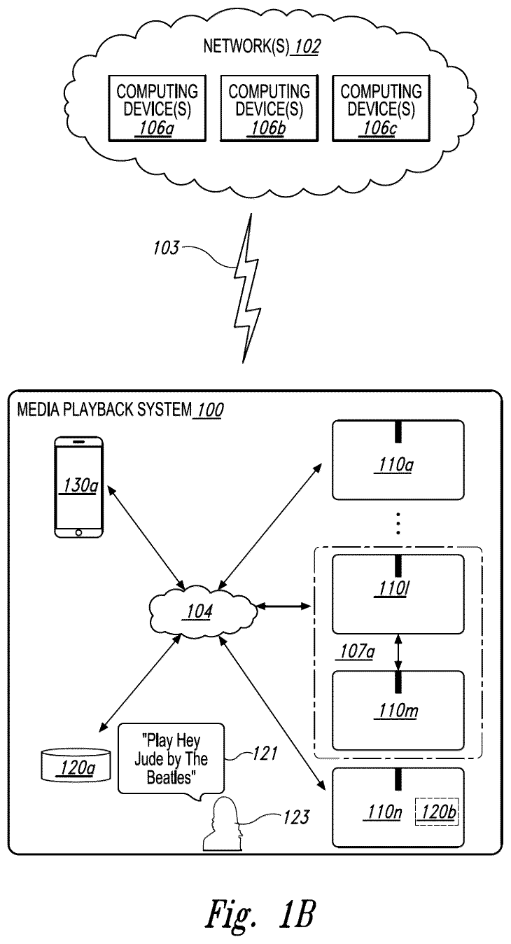

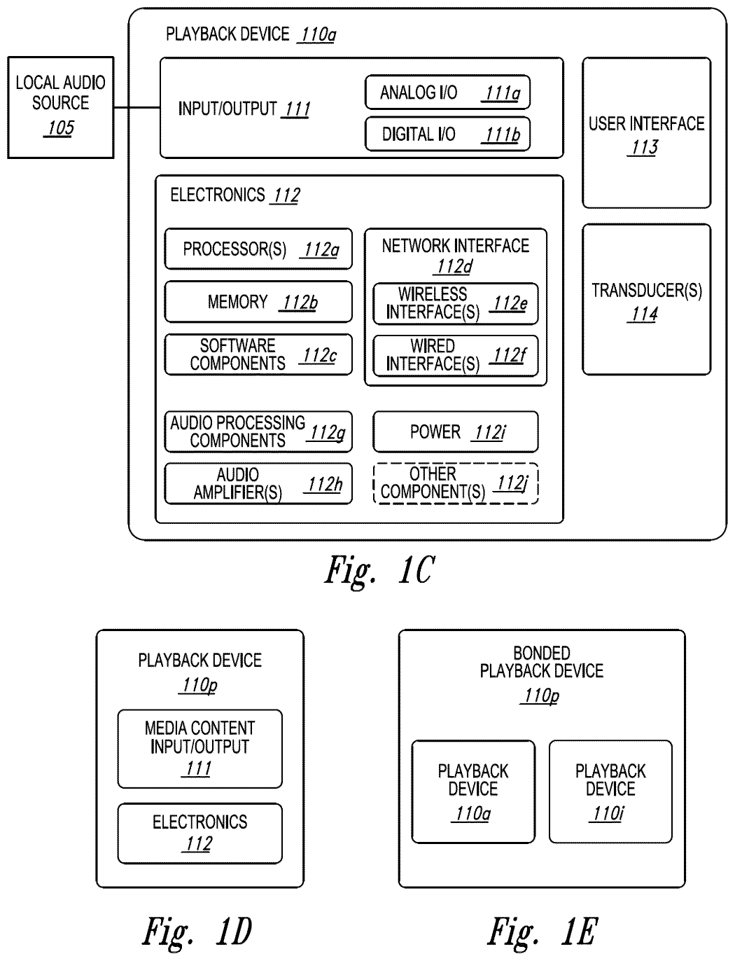

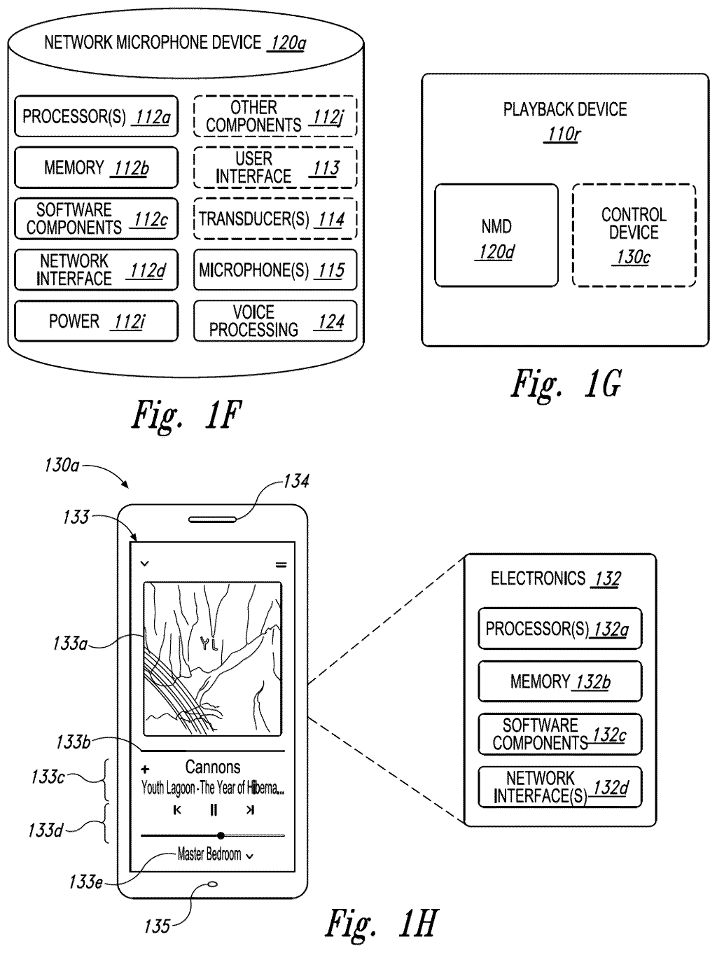

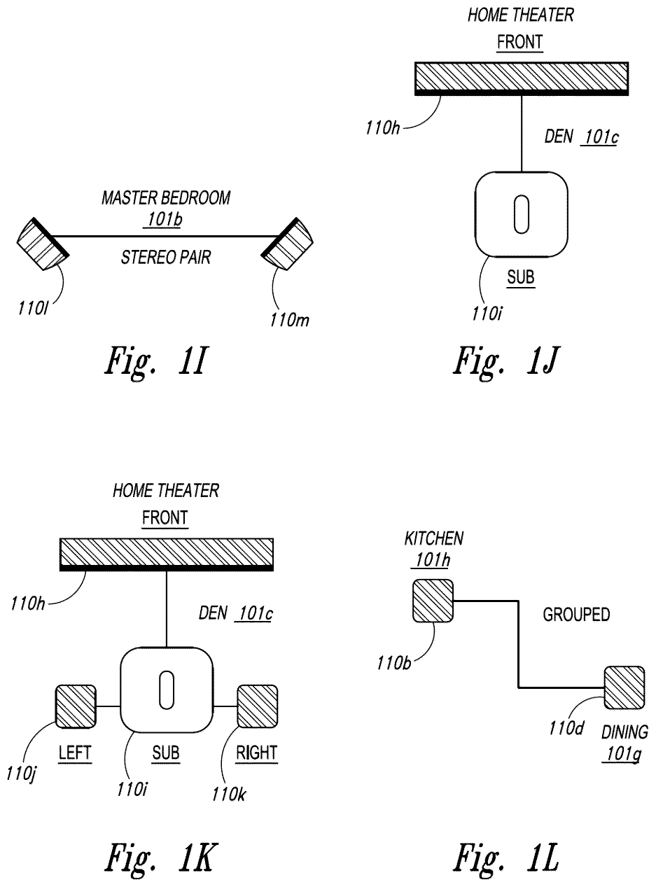

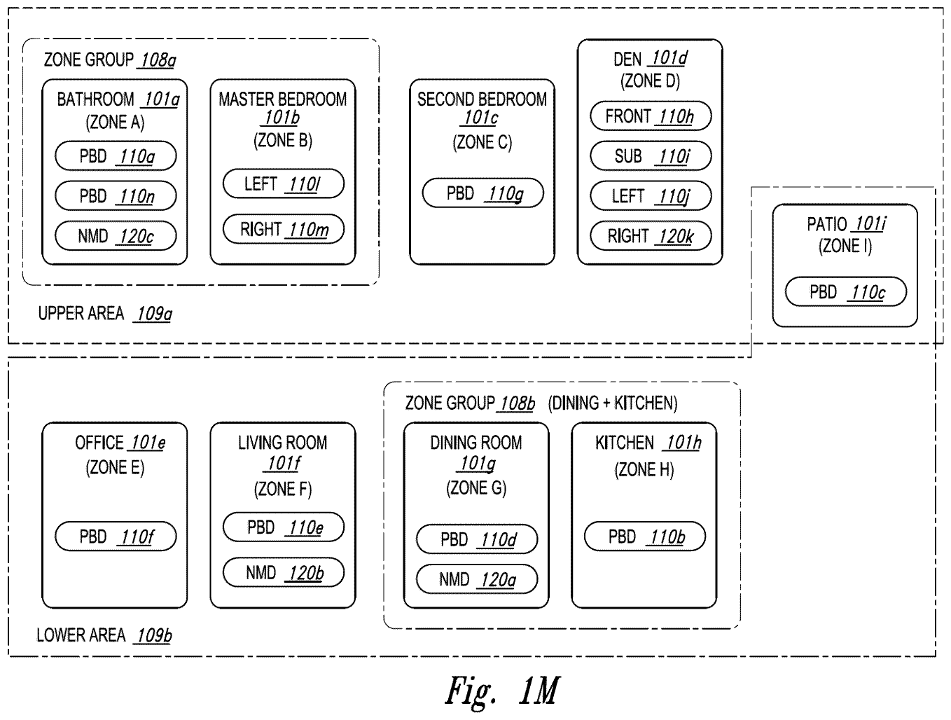

In the Figures, identical reference numbers identify generally similar, and/or identical, elements. To facilitate the discussion of any particular element, the most significant digit or digits of a reference number refers to the Figure in which that element is first introduced. For example, element 110a is first introduced and discussed with reference to FIG. 1A. Many of the details, dimensions, angles and other features shown in the Figures are merely illustrative of particular embodiments of the disclosed technology. Accordingly, other embodiments can have other details, dimensions, angles and features without departing from the spirit or scope of the disclosure. In addition, those of ordinary skill in the art will appreciate that further embodiments of the various disclosed technologies can be practiced without several of the details described below.

### II. Suitable Operating Environment

FIG. 1A is a partial cutaway view of a media playback system 100 distributed in an environment 101 (e.g., a house). The media playback system 100 comprises one or more playback devices 110 (identified individually as playback devices 110a-n), one or more network microphone devices (“NMDs”), 120 (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some embodiments, a playback device includes one or more transducers or speakers powered by one or more amplifiers. In other embodiments, however, a playback device includes one of (or neither of) the speaker and the amplifier. For instance, a playback device can comprise one or more amplifiers configured to drive one or more speakers external to the playback device via a corresponding wire or cable.

Moreover, as used herein the term NMD (i.e., a “network microphone device”) can generally refer to a network device that is configured for audio detection. In some embodiments, an NMD is a stand-alone device configured primarily for audio detection. In other embodiments, an NMD is incorporated into a playback device (or vice versa).

The term “control device” can generally refer to a network device configured to perform functions relevant to facilitating user access, control, and/or configuration of the media playback system 100.

Each of the playback devices 110 is configured to receive audio signals or data from one or more media sources (e.g., one or more remote servers, one or more local devices) and play back the received audio signals or data as sound. The one or more NMDs 120 are configured to receive spoken word commands, and the one or more control devices 130 are configured to receive user input. In response to the received spoken word commands and/or user input, the media playback system 100 can play back audio via one or more of the playback devices 110. In certain embodiments, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation). In some embodiments, for example, the media playback system 100 is configured to play back audio from a first playback device (e.g., the playback device 100a) in synchrony with a second playback device (e.g., the playback device 100b). Interactions between the playback devices 110, NMDs 120, and/or control devices 130 of the media playback system 100 configured in accordance with the various embodiments of the disclosure are described in greater detail below with respect to FIGS. 1B-1L.

In the illustrated embodiment of FIG. 1A, the environment 101 comprises a household having several rooms, spaces, and/or playback zones, including (clockwise from upper left) a master bathroom 101a, a master bedroom 101b, a second bedroom 101c, a family room or den 101d, an office 101e, a living room 101f, a dining room 101g, a kitchen 101h, and an outdoor patio 101i. While certain embodiments and examples are described below in the context of a home environment, the technologies described herein may be implemented in other types of environments. In some embodiments, for example, the media playback system 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable.

The media playback system 100 can comprise one or more playback zones, some of which may correspond to the rooms in the environment 101. The media playback system 100 can be established with one or more playback zones, after which additional zones may be added, or removed to form, for example, the configuration shown in FIG. 1A. Each zone may be given a name according to a different room or space such as the office 101e, master bathroom 101a, master bedroom 101b, the second bedroom 101c, kitchen 101h, dining room 101g, living room 101f, and/or the patio 101i. In some aspects, a single playback zone may include multiple rooms or spaces. In certain aspects, a single room or space may include multiple playback zones.

In the illustrated embodiment of FIG. 1A, the master bathroom 101a, the second bedroom 101c, the office 101e, the living room 101f, the dining room 101g, the kitchen 101h, and the outdoor patio 101i each include one playback device 110, and the master bedroom 101b and the den 101d include a plurality of playback devices 110. In the master bedroom 101b, the playback devices 110l and 110m may be configured, for example, to play back audio content in synchrony as individual ones of playback devices 110, as a bonded playback zone, as a consolidated playback device, and/or any combination thereof. Similarly, in the den 101d, the playback devices 110h-j can be configured, for instance, to play back audio content in synchrony as individual ones of playback devices 110, as one or more bonded playback devices, and/or as one or more consolidated playback devices. Additional details regarding bonded and consolidated playback devices are described below with respect to, for example, FIGS. 1B and 1E and 1I-1M.

In some aspects, one or more of the playback zones in the environment 101 may each be playing different audio content. For instance, a user may be grilling on the patio 101i and listening to hip hop music being played by the playback device 110c while another user is preparing food in the kitchen 101h and listening to classical music played by the playback device 110b. In another example, a playback zone may play the same audio content in synchrony with another playback zone. For instance, the user may be in the office 101e listening to the playback device 110f playing back the same hip hop music being played back by playback device 110c on the patio 101i. In some aspects, the playback devices 110c and 110f play back the hip hop music in synchrony such that the user perceives that the audio content is being played seamlessly (or at least substantially seamlessly) while moving between different playback zones. Additional details regarding audio playback synchronization among playback devices and/or zones can be found, for example, in U.S. Pat. No. 8,234,395 entitled, “System and method for synchronizing operations among a plurality of independently clocked digital data processing devices,” which is incorporated herein by reference in its entirety for all purposes.

To facilitate synchronous playback, the playback device(s) described herein may, in some embodiments, be configurable to operate in (and/or switch between) different modes such as an audio playback group coordinator mode and/or an audio playback group member mode. While operating in the audio playback group coordinator mode, the playback device may be configured to coordinate playback within the group by, for example, performing one or more of the following functions: (i) receiving audio content from an audio source, (ii) using a clock (e.g., a physical clock or a virtual clock) in the playback device to generate playback timing information for the audio content, (iii) transmitting portions of the audio content and playback timing for the portions of the audio content to at least one other playback device (e.g., at least one other playback device operating in an audio playback group member mode), (iv) transmitting timing information (e.g., generated using the clock to the at least one other playback device; and/or (v) playing back the audio content in synchrony with the at least one other playback device using the generated playback timing information and/or the clock. While operating in the audio playback group member mode, the playback device may be configured to perform one or more of the following functions: (i) receiving audio content and playback timing for the audio content from the at least one other device (e.g., a playback device operating in an audio playback group coordinator mode); (ii) receiving timing information from the at least one other device (e.g., a playback device operating in an audio playback group coordinator mode); and/or (iii) playing the audio content in synchrony with at least the other playback device using the playback timing for the audio content and/or the timing information.

a. Suitable Media Playback System

FIG. 1B is a schematic diagram of the media playback system 100 and a cloud network 102. For ease of illustration, certain devices of the media playback system 100 and the cloud network 102 are omitted from FIG. 1B. One or more communication links 103 (referred to hereinafter as “the links 103”) communicatively couple the media playback system 100 and the cloud network 102.

The links 103 can comprise, for example, one or more wired networks, one or more wireless networks, one or more wide area networks (WAN) (e.g., the Internet), one or more local area networks (LAN) (e.g., one or more WIFI networks), one or more personal area networks (PAN) (e.g., one or more BLUETOOTH networks, Z-WAVE networks, wireless Universal Serial Bus (USB) networks, ZIGBEE networks, and/or IRDA networks), one or more telecommunication networks (e.g., one or more Global System for Mobiles (GSM) networks, Code Division Multiple Access (CDMA) networks, Long-Term Evolution (LTE) networks, 5G communication network networks, and/or other suitable data transmission protocol networks), etc. The cloud network 102 is configured to deliver media content (e.g., audio content, video content, photographs, social media content) to the media playback system 100 in response to a request transmitted from the media playback system 100 via the links 103. In some embodiments, the cloud network 102 is further configured to receive data (e.g., voice input data) from the media playback system 100 and correspondingly transmit commands and/or media content to the media playback system 100.

The cloud network 102 comprises computing devices 106 (identified separately as a first computing device 106a, a second computing device 106b, and a third computing device 106c). The computing devices 106 can comprise individual computers or servers, such as, for example, a media streaming service server storing audio and/or other media content, a voice service server, a social media server, a media playback system control server, etc. In some embodiments, one or more of the computing devices 106 comprise modules of a single computer or server. In certain embodiments, one or more of the computing devices 106 comprise one or more modules, computers, and/or servers. Moreover, while the cloud network 102 is described above in the context of a single cloud network, in some embodiments the cloud network 102 comprises a plurality of cloud networks comprising communicatively coupled computing devices. Furthermore, while the cloud network 102 is shown in FIG. 1B as having three of the computing devices 106, in some embodiments, the cloud network 102 comprises fewer (or more than) three computing devices 106.

The media playback system 100 is configured to receive media content from the networks 102 via the links 103. The received media content can comprise, for example, a Uniform Resource Identifier (URI) and/or a Uniform Resource Locator (URL). For instance, in some examples, the media playback system 100 can stream, download, or otherwise obtain data from a URI or a URL corresponding to the received media content. A network 104 communicatively couples the links 103 and at least a portion of the devices (e.g., one or more of the playback devices 110, NMDs 120, and/or control devices 130) of the media playback system 100. The network 104 can include, for example, a wireless network (e.g., a WiFi network, a Bluetooth, a Z-Wave network, a ZigBee, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WiFi” can refer to several different communication protocols including, for example, Institute of Electrical and Electronics Engineers (IEEE) 802.11a, 802.11b, 802.11g, 802.11n, 802.11ac, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHz, and/or another suitable frequency.

In some embodiments, the network 104 comprises a dedicated communication network that the media playback system 100 uses to transmit messages between individual devices and/or to transmit media content to and from media content sources (e.g., one or more of the computing devices 106). In certain embodiments, the network 104 is configured to be accessible only to devices in the media playback system 100, thereby reducing interference and competition with other household devices. In other embodiments, however, the network 104 comprises an existing household communication network (e.g., a household WiFi network). In some embodiments, the links 103 and the network 104 comprise one or more of the same networks. In some aspects, for example, the links 103 and the network 104 comprise a telecommunication network (e.g., an LTE network, a 5G network). Moreover, in some embodiments, the media playback system 100 is implemented without the network 104, and devices comprising the media playback system 100 can communicate with each other, for example, via one or more direct or indirect connections, PANs, LANs, telecommunication networks, and/or other suitable communication links.

In some embodiments, audio content sources may be regularly added or removed from the media playback system 100. In some embodiments, for example, the media playback system 100 performs an indexing of media items when one or more media content sources are updated, added to, and/or removed from the media playback system 100. The media playback system 100 can scan identifiable media items in some or all folders and/or directories accessible to the playback devices 110, and generate or update a media content database comprising metadata (e.g., title, artist, album, track length) and other associated information (e.g., URIs, URLs) for each identifiable media item found. In some embodiments, for example, the media content database is stored on one or more of the playback devices 110, network microphone devices 120, and/or control devices 130.

In the illustrated embodiment of FIG. 1B, the playback devices 110l and 110m comprise a group 107a. The playback devices 110l and 110m can be positioned in different rooms in a household and be grouped together in the group 107a on a temporary or permanent basis based on user input received at the control device 130a and/or another control device 130 in the media playback system 100. When arranged in the group 107a, the playback devices 110l and 110m can be configured to play back the same or similar audio content in synchrony from one or more audio content sources. In certain embodiments, for example, the group 107a comprises a bonded zone in which the playback devices 110l and 110m comprise left audio and right audio channels, respectively, of multi-channel audio content, thereby producing or enhancing a stereo effect of the audio content. In some embodiments, the group 107a includes additional playback devices 110. In other embodiments, however, the media playback system 100 omits the group 107a and/or other grouped arrangements of the playback devices 110. Additional details regarding groups and other arrangements of playback devices are described in further detail below with respect to FIGS. 1-I through IM.

The media playback system 100 includes the NMDs 120a and 120d, each comprising one or more microphones configured to receive voice utterances from a user. In the illustrated embodiment of FIG. 1B, the NMD 120a is a standalone device and the NMD 120d is integrated into the playback device 110n. The NMD 120a, for example, is configured to receive voice input 121 from a user 123. In some embodiments, the NMD 120a transmits data associated with the received voice input 121 to a voice assistant service (VAS) configured to (i) process the received voice input data and (ii) transmit a corresponding command to the media playback system 100. In some aspects, for example, the computing device 106c comprises one or more modules and/or servers of a VAS (e.g., a VAS operated by one or more of SONOS®, AMAZON®, GOOGLE® APPLE®, MICROSOFT®). The computing device 106c can receive the voice input data from the NMD 120a via the network 104 and the links 103. In response to receiving the voice input data, the computing device 106c processes the voice input data (i.e., “Play Hey Jude by The Beatles”), and determines that the processed voice input includes a command to play a song (e.g., “Hey Jude”). The computing device 106c accordingly transmits commands to the media playback system 100 to play back “Hey Jude” by the Beatles from a suitable media service (e.g., via one or more of the computing devices 106) on one or more of the playback devices 110.

b. Suitable Playback Devices

FIG. 1C is a block diagram of the playback device 110a comprising an input/output 111. The input/output 11I can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some embodiments, the analog I/O 111a is an audio line-in input connection comprising, for example, an auto-detecting 3.5 mm audio line-in connection. In some embodiments, the digital I/O 111b comprises a Sony/Philips Digital Interface Format (S/PDIF) communication interface and/or cable and/or a Toshiba Link (TOSLINK) cable. In some embodiments, the digital I/O 111b comprises a High-Definition Multimedia Interface (HDMI) interface and/or cable. In some embodiments, the digital I/O 111b includes one or more wireless communication links comprising, for example, a radio frequency (RF), infrared, WiFi, Bluetooth, or another suitable communication protocol. In certain embodiments, the analog I/O 111a and the digital I/O 111b comprise interfaces (e.g., ports, plugs, jacks) configured to receive connectors of cables transmitting analog and digital signals, respectively, without necessarily including cables.

The playback device 110a, for example, can receive media content (e.g., audio content comprising music and/or other sounds) from a local audio source 105 via the input/output 111 (e.g., a cable, a wire, a PAN, a Bluetooth connection, an ad hoc wired or wireless communication network, and/or another suitable communication link). The local audio source 105 can comprise, for example, a mobile device (e.g., a smartphone, a tablet, a laptop computer) or another suitable audio component (e.g., a television, a desktop computer, an amplifier, a phonograph, a Blu-ray player, a memory storing digital media files). In some aspects, the local audio source 105 includes local music libraries on a smartphone, a computer, a networked-attached storage (NAS), and/or another suitable device configured to store media files. In certain embodiments, one or more of the playback devices 110, NMDs 120, and/or control devices 130 comprise the local audio source 105. In other embodiments, however, the media playback system omits the local audio source 105 altogether. In some embodiments, the playback device 110a does not include an input/output 111 and receives all audio content via the network 104.

The playback device 110a further comprises electronics 112, a user interface 113 (e.g., one or more buttons, knobs, dials, touch-sensitive surfaces, displays, touchscreens), and one or more transducers 114 (referred to hereinafter as “the transducers 114”). The electronics 112 is configured to receive audio from an audio source (e.g., the local audio source 105) via the input/output 111, one or more of the computing devices 106a-c via the network 104 (FIG. 1B), amplify the received audio, and output the amplified audio for playback via one or more of the transducers 114. In some embodiments, the playback device 110a optionally includes one or more microphones 115 (e.g., a single microphone, a plurality of microphones, a microphone array) (hereinafter referred to as “the microphones 115”). In certain embodiments, for example, the playback device 110a having one or more of the optional microphones 115 can operate as an NMD configured to receive voice input from a user and correspondingly perform one or more operations based on the received voice input.

In the illustrated embodiment of FIG. 1C, the electronics 112 comprise one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power 112i (e.g., one or more power supplies, power cables, power receptacles, batteries, induction coils, Power-over Ethernet (POE) interfaces, and/or other suitable sources of electric power). In some embodiments, the electronics 112 optionally include one or more other components 112j (e.g., one or more sensors, video displays, touchscreens, battery charging bases).

As described in more detail elsewhere herein, in some examples the power components 112i can include one or more of: a wireless power transmitter (e.g., a laser, induction coils, etc.), a wireless power receiver (e.g., a photovoltaic cell, induction coils, etc.), an energy storage component (e.g., a capacitor, a rechargeable battery), an energy harvester, a wired power input port, and/or associated power circuitry. In operation, the playback device 110a can be configured to transmit wireless power to one or more external devices. Additionally or alternatively, the playback device 110a can be configured to receive wireless power from one or more external transmitter devices, instead of or in addition to receiving power over a wired connection.

The processors 112a can comprise clock-driven computing component(s) configured to process data, and the memory 112b can comprise a computer-readable medium (e.g., a tangible, non-transitory computer-readable medium, data storage loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio information from an audio source (e.g., one or more of the computing devices 106a-c (FIG. 1B)), and/or another one of the playback devices 110. In some embodiments, the operations further include causing the playback device 110a to send audio information to another one of the playback devices 110a and/or another device (e.g., one of the NMDs 120). Certain embodiments include operations causing the playback device 110a to pair with another of the one or more playback devices 110 to enable a multi-channel audio environment (e.g., a stereo pair, a bonded zone).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which was incorporated by reference above.

In some embodiments, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the media playback system 100. In some aspects, for example, the state data is shared during predetermined intervals of time (e.g., every 5 seconds, every 10 seconds, every 60 seconds) among at least a portion of the devices of the media playback system 100, so that one or more of the devices have the most recent data associated with the media playback system 100.

The network interface 112d is configured to facilitate a transmission of data between the playback device 110a and one or more other devices on a data network such as, for example, the links 103 and/or the network 104 (FIG. 1B). The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receives and processes the data destined for the playback device 110a.

In the illustrated embodiment of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the network 104 (FIG. 1B) in accordance with a suitable wireless communication protocol (e.g., WiFi, Bluetooth, LTE). In some embodiments, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain embodiments, the network interface 112d includes the wired interface 112f and excludes the wireless interface 112e. In some embodiments, the electronics 112 excludes the network interface 112d altogether and transmits and receives media content and/or other data via another communication path (e.g., the input/output 111).

The audio processing components 112g are configured to process and/or filter data comprising media content received by the electronics 112 (e.g., via the input/output 111 and/or the network interface 112d) to produce output audio signals. In some embodiments, the audio processing components 112g comprise, for example, one or more digital-to-analog converters (DAC), audio preprocessing components, audio enhancement components, digital signal processors (DSPs), and/or other suitable audio processing components, modules, circuits, etc. In certain embodiments, one or more of the audio processing components 112g can comprise one or more subcomponents of the processors 112a. In some embodiments, the electronics 112 omits the audio processing components 112g. In some aspects, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some embodiments, for example, the amplifiers 112h include one or more switching or class-D power amplifiers. In other embodiments, however, the amplifiers include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G and/or class H amplifiers, and/or another suitable type of power amplifier). In certain embodiments, the amplifiers 112h comprise a suitable combination of two or more of the foregoing types of power amplifiers. Moreover, in some embodiments, individual ones of the amplifiers 112h correspond to individual ones of the transducers 114. In other embodiments, however, the electronics 112 includes a single one of the amplifiers 112h configured to output amplified audio signals to a plurality of the transducers 114. In some other embodiments, the electronics 112 omits the amplifiers 112h.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some embodiments, the transducers 114 can comprise a single transducer. In other embodiments, however, the transducers 114 comprise a plurality of audio transducers. In some embodiments, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain embodiments, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

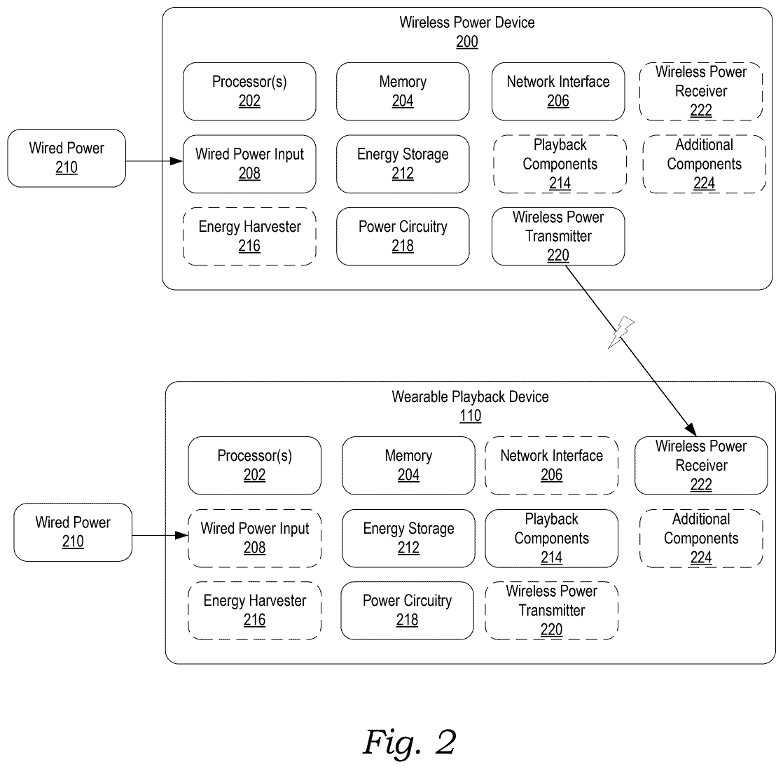

By way of illustration, SONOS, Inc. presently offers (or has offered) for sale certain playback devices including, for example, a “SONOS ONE,” “PLAY:1,” “PLAY:3,” “PLAY:5,” “PLAYBAR,” “PLAYBASE,” “CONNECT:AMP,” “CONNECT,” and “SUB.” Other suitable playback devices may additionally or alternatively be used to implement the playback devices of example embodiments disclosed herein. Additionally, one of ordinary skill in the art will appreciate that a playback device is not limited to the examples described herein or to SONOS product offerings. In some embodiments, for example, one or more playback devices 110 comprises wired or wireless headphones (e.g., over-the-ear headphones, on-ear headphones, in-ear earphones, bone conduction headphones, etc.). The headphone may comprise a headband coupled to one or more earcups. For example, a first earcup may be coupled to a first end of the headband and a second earcup may be coupled to a second end of the headband that is opposite the first end. Each of the one or more earcups may house any portion of the electronic components in the playback device, such as one or more transducers. Further, the one or more earcups may include a user interface for controlling operation of the headphone such as for controlling audio playback, volume level, and other functions. The user interface may include any of a variety of control elements such as buttons, knobs, dials, touch-sensitive surfaces, and/or touchscreens. An ear cushion may be coupled to each of the one or more earcups. The ear cushions may provide a soft barrier between the head of a user and the one or more earcups to improve user comfort and/or provide acoustic isolation from the ambient (e.g., provide passive noise reduction (PNR)). Additionally (or alternatively), the headphone may employ active noise reduction (ANR) techniques to further reduce the user's perception of outside noise during playback. In various examples, including some examples described below with respect to FIGS. 2-6, the playback device 110 can take the form of in-ear earphones that are configured to extend at least partially within a user's ears and be operated wirelessly and/or via a wire or cable.

In some instances, the headphone device may take the form of a hearable device. Hearable devices may include those headphone devices (e.g., ear-level devices) that are configured to provide a hearing enhancement function while also supporting playback of media content (e.g., streaming media content from a user device over a PAN, streaming media content from a streaming music service provider over a WLAN and/or a cellular network connection, etc.). In some instances, a hearable device may be implemented as an in-ear headphone device that is configured to playback an amplified version of at least some sounds detected from an external environment (e.g., all sound, select sounds such as human speech, etc.).

In some embodiments, one or more of the playback devices 110 comprise a docking station and/or an interface configured to interact with a docking station for personal mobile media playback devices. In certain embodiments, a playback device may be integral to another device or component such as a television, a lighting fixture, or some other device for indoor or outdoor use. In some embodiments, a playback device omits a user interface and/or one or more transducers. For example, FIG. 1D is a block diagram of a playback device 110p comprising the input/output 111 and electronics 112 without the user interface 113 or transducers 114.

FIG. 1E is a block diagram of a bonded playback device 110q comprising the playback device 110a (FIG. 1C) sonically bonded with the playback device 110i (e.g., a subwoofer) (FIG. 1A). In the illustrated embodiment, the playback devices 110a and 110i are separate ones of the playback devices 110 housed in separate enclosures. In some embodiments, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 110l and 110m of FIG. 1B). In some embodiments, for example, the playback device 110a is a full-range playback device configured to render low frequency, mid-range frequency, and high frequency audio content, and the playback device 110i is a subwoofer configured to render low frequency audio content. In some aspects, the playback device 110a, when bonded with the first playback device, is configured to render only the mid-range and high frequency components of a particular audio content, while the playback device 110i renders the low frequency component of the particular audio content. In some embodiments, the bonded playback device 110q includes additional playback devices and/or another bonded playback device.

c. Suitable Network Microphone Devices (NMDs)

FIG. 1F is a block diagram of the NMD 120a (FIGS. 1A and 1B). The NMD 120a includes one or more voice processing components 124 (hereinafter “the voice components 124”) and several components described with respect to the playback device 110a (FIG. 1C) including the processors 112a, the memory 112b, the power components 112i, and the microphones 115. As described elsewhere herein, the power components 112i can include one or more of: a wireless power transmitter (e.g., a laser, induction coils, etc.), a wireless power receiver (e.g., a photovoltaic cell, induction coils, etc.), an energy storage component (e.g., a capacitor, a rechargeable battery), an energy harvester, a wired power input port, and/or associated power circuitry. In operation, an NMD 120a can be configured to transmit wireless power to one or more external devices. Additionally or alternatively, the NMD 120a can be configured to receive wireless power from one or more external transmitter devices, in addition to or instead of receiving power over a wired connection.

The NMD 120a optionally comprises other components also included in the playback device 110a (FIG. 1C), such as the user interface 113 and/or the transducers 114. In some embodiments, the NMD 120a is configured as a media playback device (e.g., one or more of the playback devices 110), and further includes, for example, one or more of the audio processing components 112g (FIG. 1C), the transducers 114, and/or other playback device components. In certain embodiments, the NMD 120a comprises an Internet of Things (IoT) device such as, for example, a thermostat, alarm panel, fire and/or smoke detector, etc. In some embodiments, the NMD 120a comprises the microphones 115, the voice processing 124, and only a portion of the components of the electronics 112 described above with respect to FIG. 1B. In some aspects, for example, the NMD 120a includes the processor 112a and the memory 112b (FIG. 1B), while omitting one or more other components of the electronics 112. In some embodiments, the NMD 120a includes additional components (e.g., one or more sensors, cameras, thermometers, barometers, hygrometers).

In some embodiments, an NMD can be integrated into a playback device. FIG. 1G is a block diagram of a playback device 110r comprising an NMD 120d. The playback device 110r can comprise many or all of the components of the playback device 110a and further include the microphones 115 and voice processing 124 (FIG. 1F). The playback device 110r optionally includes an integrated control device 130c. The control device 130c can comprise, for example, a user interface (e.g., the user interface 113 of FIG. 1B) configured to receive user input (e.g., touch input, voice input) without a separate control device. In other embodiments, however, the playback device 110r receives commands from another control device (e.g., the control device 130a of FIG. 1B).

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing 124 receives and analyzes the microphone data to determine whether a voice input is present in the microphone data. The voice input can comprise, for example, an activation word followed by an utterance including a user request. As those of ordinary skill in the art will appreciate, an activation word is a word or other audio cue that signifying a user voice input. For instance, in querying the AMAZON® VAS, a user might speak the activation word “Alexa.” Other examples include “Ok, Google” for invoking the GOOGLE® VAS and “Hey, Siri” for invoking the APPLE® VAS.

After detecting the activation word, voice processing 124 monitors the microphone data for an accompanying user request in the voice input. The user request may include, for example, a command to control a third-party device, such as a thermostat (e.g., NEST® thermostat), an illumination device (e.g., a PHILIPS HUE® lighting device), or a media playback device (e.g., a Sonos® playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home.

d. Suitable Control Devices

FIG. 1H is a partially schematic diagram of the control device 130a (FIGS. 1A and 1B). As used herein, the term “control device” can be used interchangeably with “controller” or “control system.” Among other features, the control device 130a is configured to receive user input related to the media playback system 100 and, in response, cause one or more devices in the media playback system 100 to perform an action(s) or operation(s) corresponding to the user input. In the illustrated embodiment, the control device 130a comprises a smartphone (e.g., an iPhone™ an Android phone) on which media playback system controller application software is installed. In some embodiments, the control device 130a comprises, for example, a tablet (e.g., an iPad™) a computer (e.g., a laptop computer, a desktop computer), and/or another suitable device (e.g., a television, an automobile audio head unit, an IoT device). In certain embodiments, the control device 130a comprises a dedicated controller for the media playback system 100. In other embodiments, as described above with respect to FIG. 1G, the control device 130a is integrated into another device in the media playback system 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the media playback system 100. The memory 132b can comprise data storage that can be loaded with one or more of the software components executable by the processor 132a to perform those functions. The software components 132c can comprise applications and/or other executable software configured to facilitate control of the media playback system 100. The memory 112b can be configured to store, for example, the software components 132c, media playback system controller application software, and/or other data associated with the media playback system 100 and the user.

The network interface 132d is configured to facilitate network communications between the control device 130a and one or more other devices in the media playback system 100, and/or one or more remote devices. In some embodiments, the network interface 132d is configured to operate according to one or more suitable communication industry standards (e.g., infrared, radio, wired standards including IEEE 802.3, wireless standards including IEEE 802.11a, 802.11b, 802.11 g, 802.11n, 802.11ac, 802.15, 4G, LTE). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection) from the control device 130a to one or more of playback devices. The network interface 132d can also transmit and/or receive configuration changes such as, for example, adding/removing one or more playback devices to/from a zone, adding/removing one or more zones to/from a zone group, forming a bonded or consolidated player, separating one or more playback devices from a bonded or consolidated player, among others. Additional description of zones and groups can be found below with respect to FIGS. 1-I through 1M.

The user interface 133 is configured to receive user input and can facilitate control of the media playback system 100. The user interface 133 includes media content art 133a (e.g., album art, lyrics, videos), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated embodiment, the user interface 133 comprises a display presented on a touch screen interface of a smartphone (e.g., an iPhone™, an Android phone). In some embodiments, however, user interfaces of varying formats, styles, and interactive sequences may alternatively be implemented on one or more network devices to provide comparable control access to a media playback system.

The one or more speakers 134 (e.g., one or more transducers) can be configured to output sound to the user of the control device 130a. In some embodiments, the one or more speakers comprise individual transducers configured to correspondingly output low frequencies, mid-range frequencies, and/or high frequencies. In some aspects, for example, the control device 130a is configured as a playback device (e.g., one of the playback devices 110). Similarly, in some embodiments the control device 130a is configured as an NMD (e.g., one of the NMDs 120), receiving voice commands and other sounds via the one or more microphones 135.

The one or more microphones 135 can comprise, for example, one or more condenser microphones, electret condenser microphones, dynamic microphones, and/or other suitable types of microphones or transducers. In some embodiments, two or more of the microphones 135 are arranged to capture location information of an audio source (e.g., voice, audible sound) and/or configured to facilitate filtering of background noise. Moreover, in certain embodiments, the control device 130a is configured to operate as a playback device and an NMD. In other embodiments, however, the control device 130a omits the one or more speakers 134 and/or the one or more microphones 135. For instance, the control device 130a may comprise a device (e.g., a thermostat, an IoT device, a network device) comprising a portion of the electronics 132 and the user interface 133 (e.g., a touch screen) without any speakers or microphones.

e. Suitable Playback Device Configurations

FIGS. 1-I through 1M show example configurations of playback devices in zones and zone groups. Referring first to FIG. 1M, in one example, a single playback device may belong to a zone. For example, the playback device 110g in the second bedroom 101c (FIG. 1A) may belong to Zone C. In some implementations described below, multiple playback devices may be “bonded” to form a “bonded pair” which together form a single zone. For example, the playback device 110l (e.g., a left playback device) can be bonded to the playback device 110l (e.g., a left playback device) to form Zone A. Bonded playback devices may have different playback responsibilities (e.g., channel responsibilities). In another implementation described below, multiple playback devices may be merged to form a single zone. For example, the playback device 110h (e.g., a front playback device) may be merged with the playback device 110i (e.g., a subwoofer), and the playback devices 110j and 110k (e.g., left and right surround speakers, respectively) to form a single Zone D. In another example, the playback devices 110g and 110h can be merged to form a merged group or a zone group 108b. The merged playback devices 110g and 110h may not be specifically assigned different playback responsibilities. That is, the merged playback devices 110h and 110i may, aside from playing audio content in synchrony, each play audio content as they would if they were not merged.

Each zone in the media playback system 100 may be provided for control as a single user interface (UI) entity. For example, Zone A may be provided as a single entity named Master Bathroom. Zone B may be provided as a single entity named Master Bedroom. Zone C may be provided as a single entity named Second Bedroom.

Playback devices that are bonded may have different playback responsibilities, such as responsibilities for certain audio channels. For example, as shown in FIG. 1-I, the playback devices 110l and 110m may be bonded so as to produce or enhance a stereo effect of audio content. In this example, the playback device 110l may be configured to play a left channel audio component, while the playback device 110k may be configured to play a right channel audio component. In some implementations, such stereo bonding may be referred to as “pairing.”

Additionally, bonded playback devices may have additional and/or different respective speaker drivers. As shown in FIG. 1J, the playback device 110h named Front may be bonded with the playback device 110i named SUB. The Front device 110h can be configured to render a range of mid to high frequencies and the SUB device 110i can be configured to render low frequencies. When unbonded, however, the Front device 110h can be configured to render a full range of frequencies. As another example, FIG. 1K shows the Front and SUB devices 110h and 110i further bonded with Left and Right playback devices 110j and 110k, respectively. In some implementations, the Right and Left devices 110j and 102k can be configured to form surround or “satellite” channels of a home theater system. The bonded playback devices 110h, 110i, 110j, and 110k may form a single Zone D (FIG. 1M).

Playback devices that are merged may not have assigned playback responsibilities, and may each render the full range of audio content the respective playback device is capable of. Nevertheless, merged devices may be represented as a single UI entity (i.e., a zone, as discussed above). For instance, the playback devices 110a and 110n the master bathroom have the single UI entity of Zone A. In one embodiment, the playback devices 110a and 110n may each output the full range of audio content each respective playback devices 110a and 110n are capable of, in synchrony.

In some embodiments, an NMD is bonded or merged with another device so as to form a zone. For example, the NMD 120b may be bonded with the playback device 110e, which together form Zone F, named Living Room. In other embodiments, a stand-alone network microphone device may be in a zone by itself. In other embodiments, however, a stand-alone network microphone device may not be associated with a zone. Additional details regarding associating network microphone devices and playback devices as designated or default devices may be found, for example, in previously referenced U.S. patent application Ser. No. 15/438,749.

Zones of individual, bonded, and/or merged devices may be grouped to form a zone group. For example, referring to FIG. 1M, Zone A may be grouped with Zone B to form a zone group 108a that includes the two zones. Similarly, Zone G may be grouped with Zone H to form the zone group 108b. As another example, Zone A may be grouped with one or more other Zones C-I. The Zones A-I may be grouped and ungrouped in numerous ways. For example, three, four, five, or more (e.g., all) of the Zones A-I may be grouped. When grouped, the zones of individual and/or bonded playback devices may play back audio in synchrony with one another, as described in previously referenced U.S. Pat. No. 8,234,395. Playback devices may be dynamically grouped and ungrouped to form new or different groups that synchronously play back audio content.

In various implementations, the zones in an environment may be the default name of a zone within the group or a combination of the names of the zones within a zone group. For example, Zone Group 108b can be assigned a name such as “Dining+Kitchen”, as shown in FIG. 1M. In some embodiments, a zone group may be given a unique name selected by a user.

Certain data may be stored in a memory of a playback device (e.g., the memory 112b of FIG. 1C) as one or more state variables that are periodically updated and used to describe the state of a playback zone, the playback device(s), and/or a zone group associated therewith. The memory may also include the data associated with the state of the other devices of the media system and shared from time to time among the devices so that one or more of the devices have the most recent data associated with the system.

In some embodiments, the memory may store instances of various variable types associated with the states. Variables instances may be stored with identifiers (e.g., tags) corresponding to type. For example, certain identifiers may be a first type “a1” to identify playback device(s) of a zone, a second type “b1” to identify playback device(s) that may be bonded in the zone, and a third type “c1” to identify a zone group to which the zone may belong. As a related example, identifiers associated with the second bedroom 101c may indicate that the playback device is the only playback device of the Zone C and not in a zone group. Identifiers associated with the Den may indicate that the Den is not grouped with other zones but includes bonded playback devices 110h-110k. Identifiers associated with the Dining Room may indicate that the Dining Room is part of the Dining+Kitchen zone group 108b and that devices 110b and 110d are grouped (FIG. 1L). Identifiers associated with the Kitchen may indicate the same or similar information by virtue of the Kitchen being part of the Dining+Kitchen zone group 108b. Other example zone variables and identifiers are described below.

In yet another example, the media playback system 100 may variables or identifiers representing other associations of zones and zone groups, such as identifiers associated with Areas, as shown in FIG. 1M. An area may involve a cluster of zone groups and/or zones not within a zone group. For instance, FIG. 1M shows an Upper Area 109a including Zones A-D, and a Lower Area 109b including Zones E-I. In one aspect, an Area may be used to invoke a cluster of zone groups and/or zones that share one or more zones and/or zone groups of another cluster. In another aspect, this differs from a zone group, which does not share a zone with another zone group. Further examples of techniques for implementing Areas may be found, for example, in U.S. application Ser. No. 15/682,506 filed Aug. 21, 2017 and titled “Room Association Based on Name,” and U.S. Pat. No. 8,483,853 filed Sep. 11, 2007, and titled “Controlling and manipulating groupings in a multi-zone media system.” Each of these applications is incorporated herein by reference in its entirety for all purposes. In some embodiments, the media playback system 100 may not implement Areas, in which case the system may not store variables associated with Areas.

### III. Wirelessly Powering Wearable Audio Playback Devices

Wearable devices are often configured for wireless operation, for instance by including an integrated energy storage (e.g., a rechargeable battery) and other components for wireless data communication. Examples of such wearable devices include wearable audio playback devices such as headphone devices (e.g., over-ear headphones, on-ear headphones, in-ear headphone devices such as earbuds, etc.), smartglasses, headsets, extended-, virtual-, augmented-, or mixed-reality visors or headsets with integrated audio output components, smartwatches, or other suitable form factor. In various examples, a wearable audio playback device can be configured to receive wireless power. To enable this functionality, the wearable audio playback device can include a wireless power receiver therein. At least a portion of the wireless power receiver (e.g., a charging coil or other suitable components) can be disposed within select portions of the wearable playback device in a manner that conserves internal space for audio playback and other components. Among examples, wireless power receiver components, such as a charging coil, can be disposed within an ear cushion or a headband of a wearable playback device.

In operation, one or more wireless power transmitter devices can be provided in the vicinity of the wearable audio playback device. For instance, a wireless power device, which is configured to transmit wireless power to the wearable audio playback device, can be integrated into a charging case, a charging stand, or other suitable configuration that allows for wireless charging of the wearable playback device.

As used herein, a “wireless power transmitter” or “transmitter device” includes any device (or component(s) of a device) capable of sending wireless power that can be received and recovered by a suitable receiver device. Similarly, a “wireless power receiver” or “receiver device” includes any device (or component(s) of a device) capable of receiving wireless power from a remote transmitter device and utilizing that power to a) charge an onboard battery (or other energy storage device) and/or b) operate one or more components of the receiver device (e.g., to power at least one amplifier of a playback device or to otherwise contribute to operation of a playback device). In various examples, a single playback device (or other device) can be both a wireless power transmitter and a wireless power receiver, while in other examples a particular device may be only a transmitter device or only a receiver device.

In various examples disclosed herein, such wireless power transfer can include short-range wireless power transfer technologies, for instance being configured to transmit power over distances of less than 10 cm. In various implementations, short-range wireless power transfer can include devices configured to transmit power over a distance of less than 9 cm, 8 cm, 7 cm, 6 cm, 5 cm, 4 cm, 3 cm, or less. Examples of such technologies include the Qi standard (Wireless Power Consortium) and the PMA standard (Power Matters Alliance).

Among examples, the wireless power transmitter device can include a transmitter coil and the wireless power receiver device can include a receiver coil. When the receiver coil is placed within close proximity to the transmitter coil (typically directly on top of or adjacent to the transmitter coil), the transmitter coil generates an alternating electromagnetic field that induces an electric current in the receiver coil. This induced current is then used to charge the battery or power the electronics in the receiver device. In some implementations, the wireless power transmitter coil can operate within a frequency range of 110 kHz to 205 kHz for low power applications (e.g., up to 5 W), and 80-300 kHz for medium power applications (e.g., up to 120 W). Optionally, the wireless power charging can also include provisions for foreign object detection (FOD) to prevent heating of metallic objects inadvertently placed on the charger, as well as communication protocols between the transmitter and receiver to optimize power transfer and ensure safety.

In the context of the present technology, short-range wireless power transfer techniques such as Qi charging can be used to wirelessly charge the wearable playback device 110 when it is placed in close proximity to a compatible wireless power device 200 such as a charging case, stand, or pad. This can provide a convenient and cable-free way for users to recharge their wearable playback devices. However, the relatively short range of these techniques may require more precise alignment between the transmitter and receiver coils compared to mid- or long-range wireless power transfer approaches. The choice of wireless power transfer technology may depend on factors such as the desired charging range, the size and position of the coils in the devices, compatibility with existing standards and devices, and cost considerations, mid-range, and/or long-range wireless power transfer.

In some examples, the wearable playback device 110 can be configured for charging using mid- or long-range wireless power transfer. As used herein, mid- and long-range wireless power transfer includes wireless power transfer capability over a distance of greater than about 10 cm, or in some examples greater than about 50 cm or greater than about 1 m. For example, in some instances a wireless power transmitter device and a wireless power receiver device can be separated from one another by at least about 10 cm, at least about 50 cm, or at least about 1 m during wireless power transfer. In some examples, the distance is greater than 1 m (e.g., 5 m, 10 m, 20 m, 100 m or more than 100 m). In other examples, the distances may be less than 10 cm. For instance, in some examples, a wireless power transmitter and receiver may only be separated by a distance less than 1 cm, even if one or both of the transmitter and receiver are capable of transmitting over longer distances.

As noted elsewhere herein, such mid- or long-range wireless power transfer technologies include radiative techniques (e.g., lasers, radio waves, microwaves, or other such propagation of electromagnetic radiation from the transmitter device towards the receiver device). In various examples, the wireless power receiver in such instances can include a photovoltaic cell, a diode, an antenna (e.g., a rectenna), or other suitable hardware that can convert electromagnetic radiation into electrical energy. Similarly, the wireless power transmitter in such instances can include an optical source such as a laser, a microwave source, an antenna (e.g., directional antennas, phased array antennas, etc.), or other suitable source of electromagnetic radiation.

Additionally or alternatively, such mid- or long-range wireless power transmission can include non-radiative transmission such as electromagnetic coupling (e.g., inductive coupling, resonant inductive coupling, capacitive coupling, resonant capacitive coupling, magnetodynamic coupling, magnetic resonance coupling, transformer coupling, etc.). In such instances, both the wireless power transmitter and the wireless power receiver can include electrically conductive coils (e.g., in the case of inductive coupling), electrodes (e.g., in the case of capacitive coupling), or rotating armatures carrying magnets thereon (e.g., in the case of magnetodynamic coupling). In certain examples, the wireless power transmission includes sending and transmitting ultrasound. In these scenarios, for instance, the transmitting and receiving devices can include one or more ultrasound transducers. In some examples, one or more of the devices comprises an ultrasound array comprising several ultrasound elements configured to operate as a phased array to transmit ultrasound energy in a particular direction toward a similarly equipped (or perhaps differently equipped) receiver device.

In some examples, the wearable audio playback device and/or the wireless power device can include both a wireless power receiver and a wireless power transmitter, such that the device may be used in either configuration, or in some instances may be used in both configurations simultaneously (e.g., as a “relay” in which a device receives wireless power from an external transmitter device and transmits wireless power to an external receiver device). In some instances, a plurality of such devices can transfer wireless power among one another in a mesh configuration, with the particular device-to-device transmission being selected to provide the desired power levels, device performance, and user experience. Additional examples of wireless power transmission and other power management techniques are provided in: International Application No. PCT/US2021/071327, entitled “Wireless Power Transfer for Audio Playback Devices,” filed Aug. 31, 2021; and in International Application No. PCT/US23/707711, entitled “Power Management for Audio Playback Devices,” filed Jul. 21, 2023, each of which is hereby incorporated by reference in its entirety for all purposes.

### a. Example Wireless Power Transfer to Wearable Audio Playback Devices

FIG. 2 is a schematic block diagram of a wireless power device 200 configured to supply wireless power to a wearable playback device 110 having integrated wireless power transfer components. In various implementations, the playback device 110 can be a wearable or portable audio playback device (e.g., in-ear device such as earbuds, on-ear or over-ear headphones, a hand-carryable playback device, an extended reality (XR) device such as goggles, a visor, smartglasses, etc.). Among examples, the wireless power device 200 can also be a carrying case for the wearable playback device 110, a stand for the wearable playback device 110, a charging pad for the wearable playback device 110, another playback device configured to provide wireless charging for the wearable playback device 110, or any other suitable form factor or configuration. In operation, when a user engages the wearable playback device 110 with the wireless power device 200 (e.g., placing the wearable playback device 110 in its case, on its stand or pad, within a predefined proximity of the wireless power device 200, or otherwise engages with the wireless power device 200), the wireless power device 200 can be within a predetermined distance and/or orientation (e.g., alignment, separation distance, etc.) to facilitate wireless power transfer from the wireless power device 200 to the audio playback device 110.

As used herein, a “wireless power transfer device” (also referred to as a “WPT device”) includes any device configured to transmit power wirelessly to another receiver device and/or to receive power wirelessly from another transmitter device. In various implementations, an audio playback device can include wireless power transfer components (e.g., a transmitter and/or receiver) and as such the wearable playback device 110 can be a WPT device. In some implementations, a WPT device may omit certain audio playback components (e.g., amplifiers, transducers, etc.) and as such a WPT device may not be an audio playback device.

As shown in FIG. 2, a wireless power device 200 (which can be a WPT device) can include one or more processors 202, a memory 204, and a network interface 206. These can be similar to, identical to, or include, processors 112a, memory 112b, and network interface 112d described above with respect to FIGS. 1C and 1F. In various examples, the wireless power device 200 can include any or all of the features of playback device 110a or NMD 120a described previously herein. In some examples, the network interface 206 can include one or more transceivers that are configured to communicate via at least one WIFI network, and/or at least one BLUETOOTH network.

Wireless power device 200 optionally includes a wired power input port 208 that is configured to be electrically coupled to wired power 210 (e.g., via 110/220V wall power, a USB-C charger, etc.), such as an AC power port or a USB port (e.g., a USB TYPE-A port, a USB TYPE-B port, a USB TYPE-C port, etc.). The power input port 208 can be coupled (e.g., via cable) directly to a household power outlet (e.g., to receive alternating current (AC) power) or indirectly via a power adapter (e.g., a device that converts the AC power from the household power outlet to direct current (DC) power). In some examples, the wired power input port 208 is omitted, and the wireless power device 200 operates solely on the basis of power received wirelessly from external transmitter device(s) and/or energy generated via energy harvester(s) 216.

The wireless power device 200 further includes an energy storage component 212, which can take the form of a rechargeable battery, a capacitor, a supercapacitor, a hybrid capacitor, or any other suitable component that can store energy. The energy storage component 212 can be configured to store energy and to facilitate operation of the device (e.g., powering antennas for data communication). In this regard, the energy storage component 212 can be a battery that has a chemistry that facilitates recharging the battery, such as lithium-ion (Li-ion), nickel-metal hydride (NiMH), etc. The battery can be sized such that the processor(s) 202 and other components of the wireless power device 200 can operate on battery power alone for an extended amount of time without the battery needing to be recharged. The battery can be charged using power from one or more other components in the device 200 (e.g., wired power input port 208, wireless power receiver 222, energy harvester 216, etc.).

As noted previously, in some examples, the wireless power device 200 can include audio playback components 214 (e.g., one or more transducers, audio processing circuitry, microphones, voice processing circuitry, etc.), and as such the wireless power device 200 can include or be part of an audio playback device or a network microphone device as described elsewhere herein. In various examples, such an audio playback device can be a soundbar, a subwoofer, a headphone device, a hearable device, a wearable device (e.g., a smartwatch), a portable audio playback device, an architectural playback device, or a video playback device. In some examples, the audio playback components 214 are omitted, and the wireless power device 200 can supply wireless power to the playback device 110 without itself driving any audio output.

The wireless power device 200 optionally includes one or more energy harvesters 216. Energy harvesters 216 may include those devices configured to derive power from energy sources in the environment (e.g., solar energy, thermal energy, wind energy, salinity gradients, kinetic energy, sound energy, etc.). For example, the energy harvesters 216 can include one or more photovoltaic cells configured to convert received light into a voltage and current. Any of a variety of energy harvesters 216 may be included in the wireless power device 200. Examples of such energy harvesters include photovoltaic cells, thermoelectric generators, micro wind turbines, piezoelectric crystals, electroacoustic transducers, kinetic energy harvesters, and/or mechanical energy harvesters (e.g., triboelectric nanogenerators).

The wireless power device 200 can additionally include power circuitry 218 and a wireless power transmitter 220. In some implementations, the wireless power device 200 also includes a wireless power receiver 222. In operation, the wireless power device 200 can transmit wireless power to an external receiver device (e.g., playback device 110) via the transmitter 220, with the power circuitry 218 controlling some or all of the functions associated with these operations. In some examples, the wireless power transmitter 220 can be configured to transmit power below a predetermined threshold to ensure safety. For instance, the wireless power transmitter 220 can be configured to transmit less than 5 watts, 4 watts, 3 watts, 2 watts, 1 watt, 500 milliwatts, or less. In some examples, the wireless power transmitter 220 is configured to transmit power above 5 watts.

The wireless power transmitter 220 can include any component or combination of components capable of transmitting wireless power to an external wireless power receiver device. Such wireless power transfer can include short-range wireless power transfer (e.g., using Qi charging or similar). Additionally or alternatively, the wireless power transfer can include mid- or long-range wireless power transfer, for example being configured to provide effective power transfer with the transmitter and receiver separated from one another by a distance of greater than about 10 cm, or in some examples greater than about 50 cm or greater than about 1 m. In various examples, the wireless power transmitter 220 can transmit power via radiative techniques such as using lasers, radio waves, microwaves, or other such techniques involving propagation of electromagnetic radiation from the transmitter device towards the receiver device. In various embodiments, such electromagnetic radiation may be directional (e.g., directed towards one or more receiver devices) or omnidirectional (e.g., radiating in substantially all directions from the wireless power transmitter 220). In various examples, the wireless power transmitter 220 in such instances can include an optical source such as a laser, a microwave source, an antenna (e.g., directional antennas, phased array antennas, etc.), or any other source of electromagnetic radiation. In some instances, the wireless power transmitter 220 can include one or more steering components configured to direct, focus, or steer wireless power. Such steering components can include, for example, one or more lenses, mirrors, directional antennas, ultrasound arrays, waveguides, and/or other suitable components.

Additionally or alternatively, the wireless power transmitter 220 can be configured to transmit wireless power using non-radiative techniques such as electromagnetic coupling (e.g., inductive coupling, resonant inductive coupling, capacitive coupling, resonant capacitive coupling, magnetodynamic coupling, magnetic resonance coupling etc.). In such instances, the wireless power transmitter 220 can include electrically conductive coils (e.g., in the case of inductive coupling), electrodes (e.g., in the case of capacitive coupling), rotating armatures carrying magnets thereon (e.g., in the case of magnetodynamic coupling), or any other suitable structure capable of receiving power wirelessly via electromagnetic coupling.

With continued reference to FIG. 2, the wireless power device 200 can include power circuitry 218 configured to receive power from the energy storage component 212, the wired power input 208, and/or the wireless power receiver 222, and, using the power obtained therefrom, (1) charge one or more onboard batteries (or other energy storage device), (2) transmit, receive, and/or process data via the network interface 206 and processor(s) 202, and/or (3) any other suitable operations. The power circuitry 218 can be configured to perform any of a variety of power-related tasks including, for example, one or more of the following: (1) power conversion (e.g., AC-AC conversion, AC-DC conversion, DC-AC conversion, and/or DC-DC conversion); (2) power regulation; (3) battery charging; and/or (4) power monitoring (e.g., battery monitoring). Examples of electrical components that may be integrated into the power circuitry 218 include transformers, rectifiers, inverters, converters, regulators, battery chargers, and/or power management integrated circuits (PMICs). In some examples, such power circuitry 218 can be integrated into either or both the wireless power transmitter 220 and the wireless power receiver 222.

In some examples, the power circuitry 218 can include battery circuitry that facilitates monitoring a state of a battery or other energy storage component. In these examples, the battery circuitry can identify battery state information that includes information regarding one or more of the following battery states: a state-of-charge (SoC), temperature, age, and/or internal impedance. The battery circuitry can communicate the battery state information to, for example, the processor 202.

The power circuitry 218 can include regulation circuitry that facilitates converting a variable amount of voltage (e.g., a variable voltage from a battery, a variable voltage from an energy harvester, etc.) to a stable DC voltage. For example, the regulation circuitry can include switching regulator circuitry such as buck, boost, buck-boost, flyback, resonant, etc. switching regulator circuitry. The regulation circuitry can include one or more linear voltage regulators such as low-dropout (LDO) regulators. The regulation circuitry can be configured to output one or more fixed DC voltages (e.g., ±5V, ±12V) or AC voltages. In some implementations, matching circuits (passive or active) can be configured to maximize efficiencies under various conditions (e.g., load, transmitted power, environment, distance from transmitter device, etc.). Additionally or alternatively, power circuitry 218 can include an inverter, which may be particularly useful for bidirectional WPT devices.

In various examples, the wireless power device 200 can also include further components, such as one or more user interface components (e.g., touch sensitive surface, screen, buttons, etc.), one or more microphones and associated electronics (e.g., to facilitate active noise cancellation and/or acoustic echo cancellation via the wearable playback device 110), or any other suitable components.

With continued reference to FIG. 2, the wireless power device 200 can be in electrical communication with the wearable playback device 110. For instance, the wireless power device 200 can transmit power wirelessly (e.g., via wireless power transmitter 220 of the wireless power device 200) to the wearable playback device 110. The wearable playback device 110 can include some or all of the components described above with respect to the wireless power device 200. For instance, as shown in FIG. 2, the playback device 110 can include one or more processors 202, memory 204, a network interface 206, and wired power input 208 configured to receive power from a connection to wired power 210.

The wearable playback device 110 can optionally include an on-board energy storage 212 (e.g., rechargeable battery, ultracapacitor, etc.) and/or energy harvester components 216. In some implementations, the wearable playback device 110 includes no on-board energy storage and instead relies exclusively on wireless power supplied by the wireless power device 200. In the illustrated example, the wearable playback device 110 includes playback components 214 (e.g., amplifiers, audio transducers, etc.) to facilitate audio playback. Optionally, the wearable playback device 110 can also include one or more microphones and related circuitry to capture and process sound data (e.g., to process user voice comments, perform active noise cancellation, acoustic echo cancellation, or other suitable processes).

The wearable playback device 110 includes a wireless power receiver 222, which as noted above can be configured to receive wireless power from a corresponding wireless power transmitter 220 of another device (e.g., the wireless power device 200). As noted previously, power circuitry 218 can be configured to perform a variety of power-related tasks, including receiving power via the wireless power receiver 222 and providing power to various components (e.g., processor(s) 202, playback components 214), charging the energy storage 212, monitoring a state (e.g., health, charge level, etc.) of the energy storage 212, or any other suitable power-related tasks.

In some examples, instead of or in addition transmission of wireless power between the wireless power device 200 and the wearable playback device 110, the two devices can transmit data in unilateral or bilateral fashion. In some implementations, the devices can communicate over a wireless network connection via their respective network interfaces 206 (e.g., via a local area network, personal area network, Bluetooth connection, etc.). These devices may also communicate with additional devices via their respective network interfaces 206 (e.g., other audio playback devices within the environment, with remote computing devices over a wide area network, etc.). Among examples, the wireless power device 200 may obtain audio data (e.g., via one or more remote computing devices) and transmit the audio data to the wearable playback device 110 for playback.

In some examples, the wireless power device 200 can transmit data (e.g., including the audio content) to the wearable audio playback device 110 (and vice versa) via the same mechanism used to transfer wireless power. For instance, the wireless power transfer signal can be used as a carrier wave, which is then modulated to encode data therein. Among examples, the carrier wave can take the form of light emitted via a laser, the AC current through an inductive coil, etc., which can then be modulated to incorporate data therein. At the receiver device, the wireless power signal can be demodulated to recover the transmitted data while also being converted to electrical energy for operation of the receiver device. In various examples, modulation of the wireless power signal to transmit data therein can include amplitude modulation, frequency modulation, phase modulation, pulse-width modulation, spread spectrum modulation, or any other suitable modulation scheme and/or combination of modulation schemes. In at least some instances, the data transmitted via the wireless power signal can include audio content, synchronization signals, power level indicators, device identifiers, audio content metadata, power parameters, or other such data. It should be appreciated that the data to be transmitted may (or may not) be encoded according to one or more encoding schemes prior to transmission to, for example, reduce data errors in transmission (e.g., a channel encoding scheme that adds redundancy) and/or compress the data for transmission (e.g., a compression scheme that reduces the size of the data).

In some implementations, when data communication with the wearable audio playback device 110 occurs by using the wireless power transfer signal as a carrier wave, a conventional network interface (e.g., WiFi or Bluetooth antenna and associated electronics) can be omitted from the wearable audio playback device 110 altogether. This may advantageously further reduce the amount of electronic waste associated with disposing of the wearable audio playback device 110 once the device is no longer functional.

In some instances, the wearable playback device 110 may transmit data to the wireless power device 200, such as data indicative of device state or operation. For example, the data transmitted to the wireless power device 200 may relate to the power consumption, charge level, battery health, or other power parameter associated with the wearable playback device 110. In response to certain power parameters, the wireless power device 200 may modify its operation. For example, in response to an indication that the on-board energy storage 212 of the wearable playback device 110 has fallen below a predetermined threshold, the wireless power device 200 may initiate wireless power transfer to the playback device 110. As another example, in response to an indication that the on-board energy storage 212 of the playback device 110 has risen above a predetermined threshold, the wireless power device 200 may cease wireless power transfer to the wearable playback device 110. In additional examples, the wireless power device 200 may initiate, cease, or modify wireless power transmission based on data indicating a power receipt parameter (e.g., a low power receipt parameter may indicate an obstruction between the two devices, and hence power transmission may be temporarily suspended). In some instances, power transmission can be scheduled based on a user input, a detected user behavior, detected environmental conditions, other sensor data, or any other suitable input parameter.

In some implementations, a given wireless power device 200 may transmit data and/or power to multiple receiver devices, one or more of which may be wearable audio playback devices. In such cases, the wireless power device 200 may optionally send both power and data to a first set of one or more devices, while sending only one of power and/or data to a second set of one or more devices. In one example, earbuds may receive both power and data from the wireless power device 200, but a nearby user wearing battery-powered headphones may receive only data (e.g., to listen to the same audio content) without also receiving wireless power.

### b. Example Wearable Playback Device Configurations

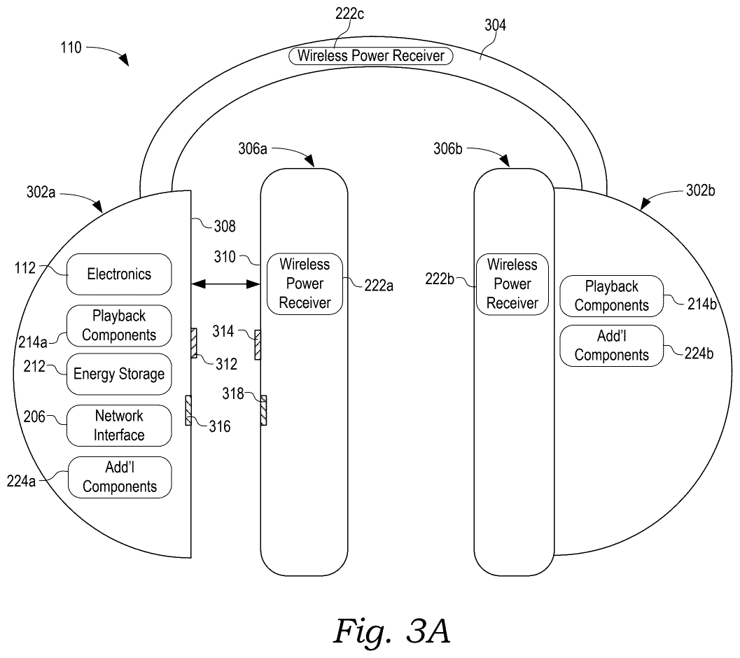

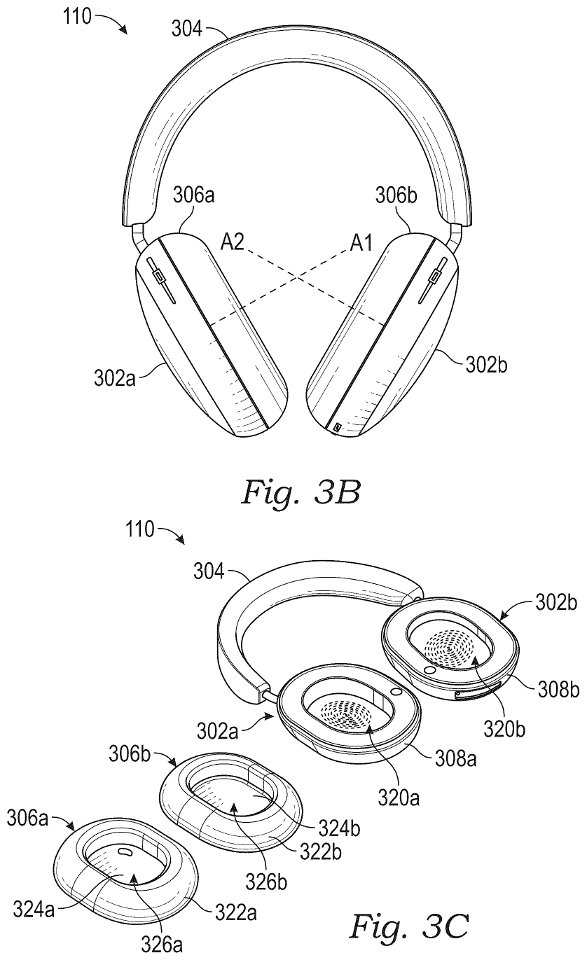

As noted previously, a wearable audio playback device 110 can assume a variety of different form factors in different implementations of the present technology. FIGS. 3A-8 illustrate a variety of example form factors for a wearable audio playback device 110. In these and other configurations, a wearable audio playback device 110 can be configured to receive some or all of its operating power via wireless power transfer from a separate wireless power device 200.

In some examples, the wearable playback device 110 may take the form of an in-ear headphone device, in which separate housings are provided for left and right ears, each with a portion configured to be placed within or adjacent to a user's ear canal. The wearable playback device 110 may also take the form of an over-ear headphone device, in which two earpieces (each configured to be placed over a user's ear) are connected via a headband configured to extend over the top of a user's head.

It should be appreciated that the wearable playback device 110 may take the form of other wearable devices separate and apart from a headphone device. Wearable devices may include those devices configured to be worn about a portion of a subject (e.g., a head, a neck, a torso, an arm, a wrist, a finger, a leg, an ankle, etc.). For example, the wearable playback device 110 may take the form of smartglasses, head-mounted displays, earrings, or any other suitable form factor.

FIG. 3A illustrates a block diagram of an example wearable playback device 110. The wearable playback device 110 takes the form of a headphone device and includes a first earcup 302a and a second earcup 302b, coupled together by a headband 304. Each earcup 302a, 302b includes a removable ear cushion 306a, 306b, respectively. The ear cushions 306a, 306b are configured to be removably coupled to the corresponding earcups 302a, 302b.

The earcups 302a, 302b each include a first contact surface 308, while the ear cushions 306a, 306b each include a second contact surface 310. When the ear cushions 306a, 306b are coupled to the earcups 302a, 302b, the first contact surface 308 and the second contact surface 310 are in contact with each other. The first contact surface 308 of each earcup 302a, 302b includes electrical contacts 312, while the second contact surface 310 of each ear cushion 306a, 306b includes corresponding electrical contacts 314. The electrical contacts 312 and 314 are configured to electrically couple the ear cushions 306a, 306b to the earcups 302a, 302b when the ear cushions are attached to the earcups.

Additionally, the first contact surface 308 of each earcup 302a, 302b includes a magnetic element 316, while the second contact surface 310 of each ear cushion 306a, 306b includes a corresponding magnetic element. The magnetic elements and are configured to facilitate alignment and secure attachment of the ear cushions 306a, 306b to the earcups 302a, 302b.

As depicted in FIG. 3A, the wearable playback device 110 can include one or more wireless power receivers 222, which may be disposed in one or both ear cushions (e.g., wireless power receiver 222a within ear cushion 306a; wireless power receiver 222b within ear cushion 306b), within the headband 304 (e.g., wireless power receiver 222c), or at any other suitable location. In some examples, the wearable playback device 110 includes only a single wireless power receiver 222, which receives and routes energy to electronic components within both earcups 302. In alternative configurations, the wearable playback device 110 can include two or more wireless power receivers 222, such that electronic components within each earcup 302 can be powered by separate wireless power receivers 222.

FIG. 3B is a front view of an example wearable playback device 110 in the form of a headphone device. As illustrated, the headband 304 is configured to extend over a user's head when worn, and to position the earcups 302 over the user's ears, with ear cushions 306 disposed between the earcups 302 and the user's ears. The first earcup 302a defines a first acoustic axis A1 and the second earcup 302b defines a second acoustic axis A2. In operation, when the device 110 is worn by the user, each acoustic axis is directed towards a corresponding one of the user's ears.

FIG. 3c is a perspective view of the wearable playback device 110 of FIG. 3B with the ear cushions 306 separated from the earcups 302. The earcups 302a and 302b can include annular contact surfaces 308a and 308b that define a cavity 320a and 320b therein. Each cushion 306 comprises a padding 322 and a barrier member 324. The padding 322 is an annular structure that provides comfort to the user when wearing the wearable playback device 110. The barrier member 324 spans across the opening of the padding 322 and is made of an acoustically transparent material, such as a fabric or scrim material. The padding 322 and the barrier member 324 together define a cavity 326 configured to receiver the user's ear therein.

In some implementations, one or both of the ear cushions 306 can have integrated wireless power receivers therein. The wireless power receivers can take different forms, such as a coil embedded within the padding 322 or a coil woven into the barrier member 324, or a coil disposed at any other location within the ear cushions 306. Such a coil can be configured to receive wireless power from an external wireless power transmitter (not shown) and provide electrical energy to the components within the earcups 302a, 302b.

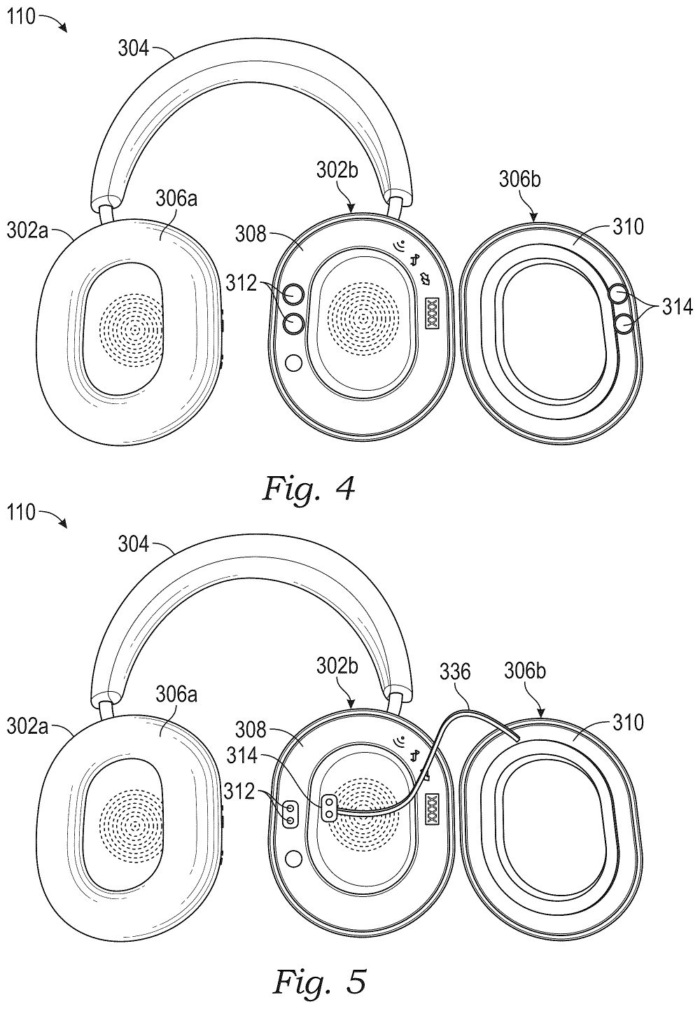

FIG. 4 is a front view of an example wearable playback device 110 with one ear cushion 306b separated from its earcup 302b. The earcups 302 can each house various components, such as audio transducers and electronic components (not shown). As illustrated, the earcup 302b includes a first contact surface 308 on its outer side, which comprises electrical contacts 312.

The ear cushion 306b is configured to be removably coupled to the earcup 302b. The ear cushion 306b includes a second contact surface 310 on its inner side, which comprises corresponding electrical contacts 314. When the ear cushion 306b is coupled to the earcup 302b, the electrical contacts 312 on the first contact surface 308 of the earcup 302b abut the electrical contacts 314 on the second contact surface 310 of the ear cushion 306b, establishing an electrical connection between the earcup 302b and the ear cushion 306b.

To ensure proper alignment and secure attachment of the ear cushion 306b to the earcup 302b, various alignment features can be employed. In one aspect, magnetic alignment features, such as first magnetic elements on the earcup 302b and corresponding second magnetic elements on the ear cushion 306, can be used. The magnetic elements can be configured to attract each other, guiding the ear cushion 306b into the correct position and holding it securely in place on the earcup 302b. The magnetic force between the magnetic elements and also ensures that the electrical contacts 312 and 314 maintain a reliable and consistent connection.

In another aspect, mechanical alignment features can be utilized to facilitate proper alignment of the ear cushion 306b and the earcup 302b. Such mechanical alignment features may include, but are not limited to, pins and corresponding holes, ridges and corresponding grooves, or snap-fit features on the earcup 302b and the ear cushion 306b. These mechanical alignment features work in conjunction with the contours of the earcup 302b and the ear cushion 306b to ensure that the ear cushion 306b is correctly positioned on the earcup 302b, thereby aligning the electrical contacts 312 and 314.

Alternatively, other alignment methods can be employed to ensure proper positioning and electrical connection between the earcup 302 and the ear cushion 306. For example, visual alignment markers, such as dots, lines, or arrows, can be provided on the earcup 302b and the ear cushion 306b to guide the user in correctly aligning and attaching the ear cushion 306b to the earcup 302b.

The removable nature of the ear cushion 306b, combined with the alignment features and the abutting electrical contacts 312 and 314, allows for easy replacement of the ear cushion 306b when necessary, while maintaining a reliable electrical connection between the ear cushion 306b and the earcup 302b. This facilitates the integration of a wireless power receiver (not shown) within the ear cushion 306b, as the electrical contacts 312 and 314 enable the transfer of power from the wireless power receiver to the components within the earcup 302b.

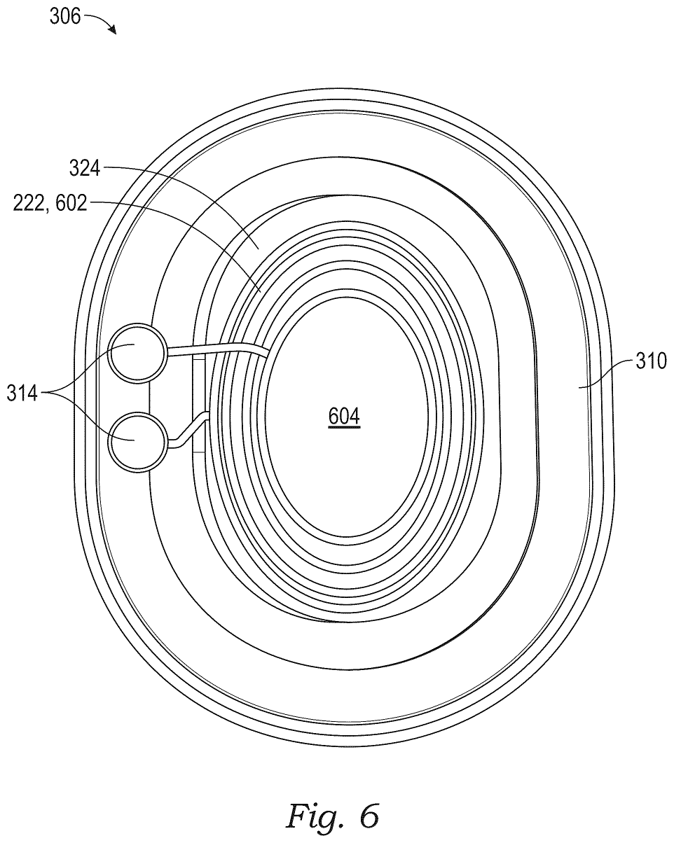

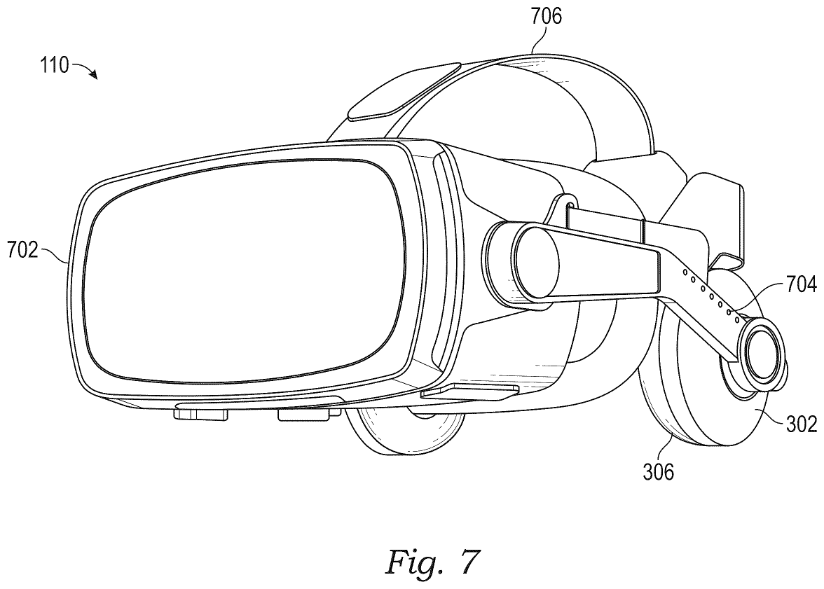

FIG. 5 is a front view of another example wearable playback device 110 with one ear cushion 306b separated from its earcup 302b. Similar to the configuration shown in FIG. 4, the earcup 302b houses various components, such as audio transducers and electronic components (not shown), and has a first contact surface 308 on its outer side. However, in this configuration, the electrical contacts 312 on the first contact surface 308 of the earcup 302b take the form of a connector or receptacle designed to receive a corresponding connector or plug.

The ear cushion 306b is configured to be removably coupled to the earcup 302b and includes a second contact surface 310 on its inner side. In this configuration, the electrical contacts 314 of the ear cushion 306b take the form of a conductive cable 336 extending away from the second contact surface 310. The conductive cable 336 is configured to be mated with the corresponding electrical contacts 312 on the first contact surface 308 of the earcup 302 when the ear cushion 306 is attached to the earcup 302b.

The conductive cable 336 can be a flexible, multi-conductor cable that carries electrical signals and power between the ear cushion 306b and the earcup 302b. The cable 336 can be of sufficient length to allow for easy connection and disconnection of the ear cushion 306b from the earcup 302b without putting undue strain on the cable 336 or the electrical contacts 312 and 314.

At the end of the conductive cable 336, a connector or plug is provided, which is designed to mate with the corresponding connector or receptacle of the electrical contacts 312 on the earcup 302. The connector or plug can be a standardized type, such as a USB-C connector, or another design specific to the wearable playback device 110. When the ear cushion 306b is attached to the earcup 302b, the connector or plug of the conductive cable 336 is inserted into the connector or receptacle of the electrical contacts 312, establishing an electrical connection between the ear cushion 306b and the earcup 302b.

As in the previous configuration, magnetic alignment features, such as magnetic elements on the earcup 302b and corresponding magnetic elements on the ear cushion 306b, can be used to ensure proper alignment and secure attachment of the ear cushion 306b to the earcup 302b. The magnetic elements and attract each other, guiding the ear cushion 306b into the correct position and holding it securely in place on the earcup 302b.

The use of a conductive cable 336 as the electrical contacts 314 of the ear cushion 306b provides a reliable and flexible means of establishing an electrical connection between the ear cushion 306b and the earcup 302b. This configuration allows for the integration of a wireless power receiver (not shown) within the ear cushion 306b, as the conductive cable 336 enables the transfer of power from the wireless power receiver to the components within the earcup 302b. Additionally, the removable nature of the ear cushion 306b and the use of a connector or plug on the conductive cable 336 facilitate easy replacement of the ear cushion 306b when necessary.

FIG. 6 is a front view of an example ear cushion 306 with components of a wireless power receiver 222 disposed therein. As illustrated, the ear cushion 306 comprises a padding 322, which is an annular structure designed to provide comfort to the user when wearing the wearable playback device 110. The padding 322 can be made of various materials, such as foam, silicone, or other suitable cushioning materials.

Spanning across the opening of the padding 322 is a barrier member 324, which can be made of an acoustically transparent material, such as a fabric or scrim material. The barrier member 324 allows sound waves generated by the audio transducer within the earcup 302 to pass through the ear cushion 306 and reach the user's ear without significant attenuation or distortion.

Embedded within or otherwise coupled to the barrier member 324 is a wireless power receiver 222, which takes the form of a conductive coil 602 defining a central aperture 604. The conductive coil 602 is configured to receive wireless power signals from an external wireless power transmitter (not shown) and convert the received signals into electrical energy that can be used to power the components within the earcup, such as the audio transducer and electronic circuitry.

The conductive coil 602 can be made of various electrically conductive materials, such as copper, aluminum, or silver, and can be formed into a flat spiral or other suitable geometry that allows for efficient reception of wireless power signals. The conductive coil 602 can be embedded within the barrier member 324 by various methods, such as weaving the coil 602 into the fabric or scrim material during the manufacturing process, or by attaching the coil 602 to the surface of the barrier member 324 using adhesives or other bonding techniques.

Alternatively, the conductive coil 602 can be disposed within the padding 322 of the ear cushion 306. In this configuration, the conductive coil 602 can be embedded within the cushioning material of the padding 322, or it can be placed in a cavity or recess formed within the padding 322. Disposing the conductive coil 602 within the padding 322 can provide additional protection for the coil 602 and can help to maintain the overall shape and integrity of the ear cushion 306.

Regardless of its specific location within the ear cushion 306, the conductive coil 602 is electrically connected to the electrical contacts 314 on the second contact surface 310 of the ear cushion 306. This electrical connection allows the power received by the conductive coil 602 to be transferred to the earcup when the ear cushion 306 is attached to the earcup 302, thereby powering the components within the earcup.

The integration of the wireless power receiver 222 in the form of a conductive coil 602 within the ear cushion 306 provides a convenient and efficient means of wirelessly charging the wearable playback device 110 without significantly altering the overall design or comfort of the device. By locating the wireless power receiver 222 within the ear cushion 306, the available space within the earcup 302 can be optimized for other components, such as larger audio transducers or batteries, while still enabling wireless charging capabilities.

FIG. 7 is a perspective view of a wearable playback device 110 in the form of an extended reality (XR) device, such as a virtual reality, augmented reality, or mixed reality display device. The device 110 includes a head-mounted display 702 that is configured to be worn on a user's head and positioned in front of the user's eyes to provide an immersive visual experience.

The head-mounted display 702 is coupled to the user's head via a pair of temple arms 704 that extend from the sides of the display 702 and rest on the user's ears. The temple arms 704 are designed to distribute the weight of the device 110 evenly and provide a secure and comfortable fit. Additionally, the device 110 includes adjustable straps 706 that extend around the top and/or back of the user's head to further secure the head-mounted display 702 in place and ensure a stable fit during use.

Coupled to the temple arms 704 of the device 110 are a pair of earcups 302, one on each side. The earcups 302 are designed to fit over the user's ears and provide an immersive audio experience to complement the visual display provided by the head-mounted display 702. Each earcup 302 includes one or more audio transducers (not shown) that generate sound waves to be delivered to the user's ears.

Removably coupled to each earcup 302 is an ear cushion 306. The ear cushions 306 are designed to provide a comfortable and secure fit against the user's ears, while also helping to isolate external noise and prevent sound leakage from the earcups 302. As described elsewhere in the present technology, the ear cushions 306 can include wireless power receiver components, such as conductive coils or other suitable structures, that are configured to receive wireless power signals from an external wireless power transmitter (not shown).

The wireless power receiver components within the ear cushions 306 are electrically connected to the earcups 302, allowing the received power to be transferred to the audio transducers and other electronic components within the earcups 302. This arrangement enables the device 110 to be wirelessly charged by simply placing the ear cushions 306 in proximity to a compatible wireless power transmitter, without the need for any external cables or connectors.

In some embodiments, the earcups 302 themselves may be removable from the temple arms 704 of the device 110. This allows the earcups 302 to be easily detached and placed on a wireless charging dock or pad for recharging, independent of the head-mounted display 702. The removable nature of the earcups 302 also facilitates easy replacement or upgrading of the audio components without the need to replace the entire device 110.

### c. Example Wireless Power Device Configurations

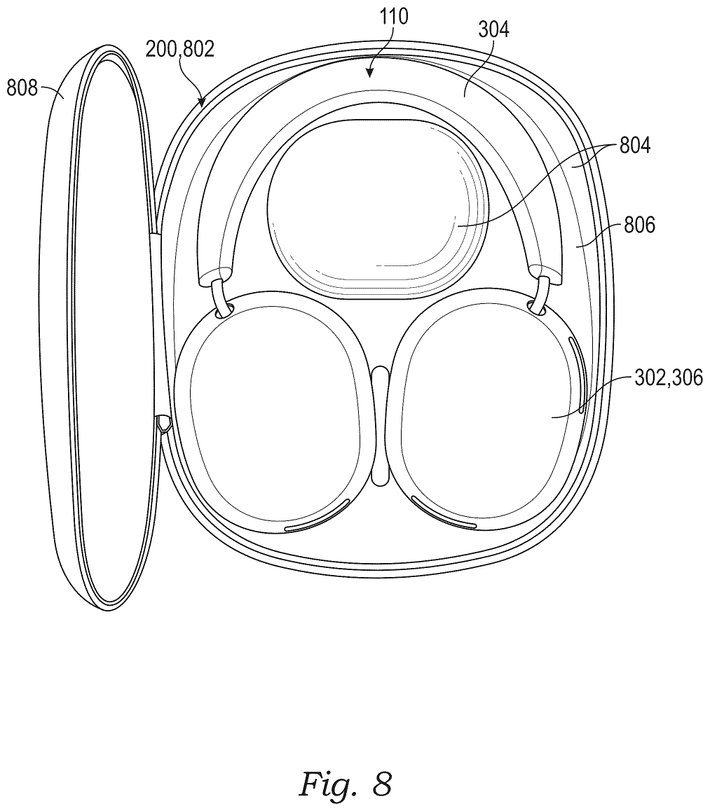

FIGS. 8, 9, and 10 illustrate example configurations for a wireless power device 200. As noted previously, the wireless power device 200 can include a wireless power transmitter 220 and be configured to wirelessly charge or otherwise supply energy to the wearable playback device 110.

FIG. 8 is a front view of a wearable playback device 110 disposed within a charging case 802. The charging case 802 takes the form of the wireless power device 200 described previously. The case 802 includes surface features 804 that define one or more recesses 806 shaped to receive the wearable playback device 110 therein. In the illustrated example, the recesses 806 are shaped to conform to the outer contours of the earcups 302 and headband 304 of the wearable playback device 110. This ensures proper alignment between the wireless power transmitter(s) 220 disposed within the case 802 and the wireless power receiver(s) 222 disposed within the ear cushions 306 of the playback device 110.

The case 802 can also include a lid 808 coupled to the main body of the case via a hinge. The lid 808 can be opened to insert or remove the playback device 110 from the case 802, and closed to protect the playback device 110 during charging and storage.

Although not visible in this view, the case 802 contains one or more wireless power transmitters 220. These transmitters are positioned within the case 802 such that, when the playback device 110 is placed into the recesses 806, the transmitters 220 are aligned with the wireless power receivers 222 integrated into one or both ear cushions 306 of the playback device 110, and/or integrated into the headband 304 of the playback device 110.

When the lid 808 is closed with the playback device 110 inside, the wireless power transmitters 220 can transmit power to the wireless power receivers 222 to recharge the battery or other energy storage component of the playback device 110. The contoured recesses 806 ensure consistent alignment between the transmitters and receivers across multiple uses.

By integrating the wireless charging functionality into a protective storage case 802, this design provides a convenient way for users to recharge their wearable playback device 110 without additional clutter or the need to precisely align the device with a separate charging base. The case 802 can be powered either by an integrated battery or via a wired connection to an external power source.

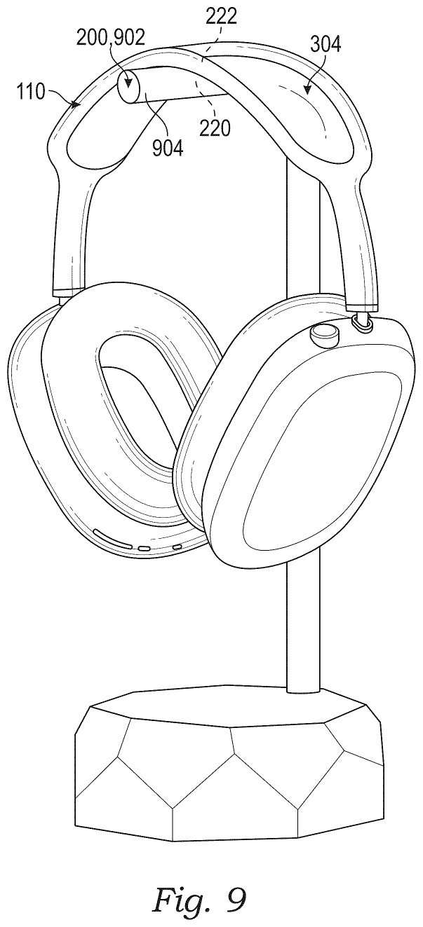

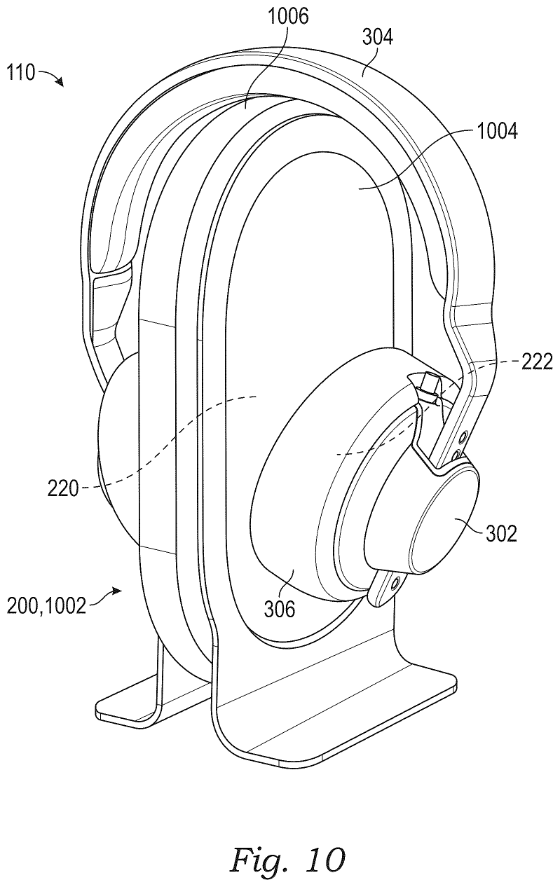

FIG. 9 is a perspective view of a wearable playback device 110 disposed on a charging stand 902 in accordance with examples of the present technology. The charging stand 902 takes the form of the wireless power device 200 described previously. The charging stand 902 includes a support portion 904 that can be curved to match the contour of the headband 304 of the wearable playback device 110. When the wearable playback device 110 is placed on the charging stand 902, the headband 304 rests on this support portion 904.

Disposed within the support portion 904 is a wireless power transmitter 220. The transmitter 220 is positioned such that it aligns with the wireless power receiver 222 integrated into the headband 304 of the wearable playback device 110 when the device is placed on the stand. This alignment allows for efficient wireless power transfer from the transmitter 220 in the stand to the receiver 222 in the headband, enabling the battery or other energy storage component of the wearable playback device 110 to be recharged.

The charging stand 902 provides a convenient and intuitive way for users to recharge their wearable playback device 110. By simply placing the device on the stand, with the headband 304 resting on the support portion 904, the device can be recharged without the need for any wires or precise alignment by the user.

FIG. 10 illustrates a perspective view of an alternative configuration of a wearable playback device 110 disposed on a charging stand 1002. Like the charging stand 902 in FIG. 9, the charging stand 1002 also functions as the wireless power device 200. The charging stand 1002 includes a base portion 1004 and a support portion 1006. The support portion 1006 is designed to support the headband 304 of the wearable playback device 110 when the device is placed on the stand for charging.

In this configuration, the wireless power transmitter 220 is disposed within the base portion 1004 of the charging stand, rather than in the support portion as in FIG. 9. The transmitter 220 is positioned and oriented such that it aligns with the wireless power receiver 222 integrated into the ear cushion 306 of the wearable playback device 110 when the device is placed on the stand.

This arrangement allows for wireless power transfer from the transmitter 220 in the base of the stand to the receiver 222 in the ear cushion, providing an alternative charging configuration compared to FIG. 9. Like the charging stand 902, the charging stand 1002 offers a simple and convenient charging solution for the wearable playback device 110, allowing the device to be recharged simply by placing it on the stand in the correct orientation.

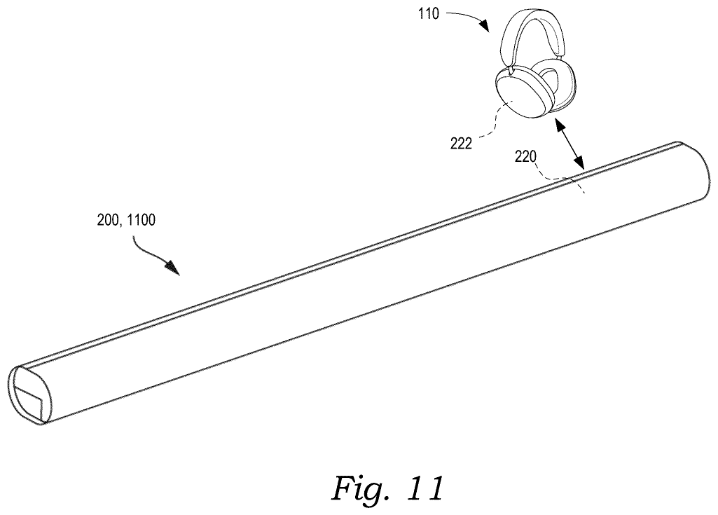

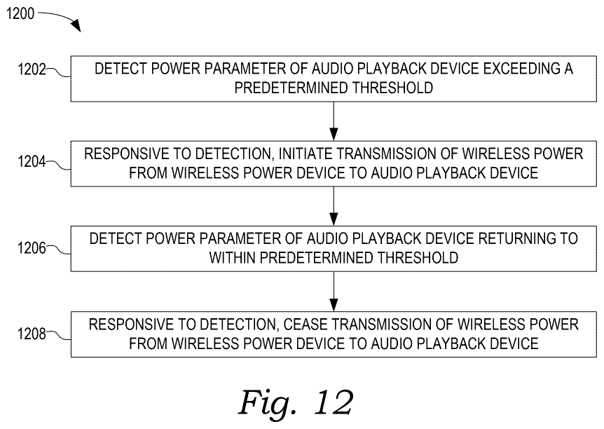

FIG. 11 is a perspective view illustrating data and power communication between a stationary playback device 1100 (e.g., a soundbar, architectural speaker, subwoofer, etc.) and a wearable playback device 110 in accordance with examples of the present technology. The stationary playback device 1100 includes a wireless power transmitter 220 that is configured to transmit wireless power to a corresponding wireless power receiver 222 disposed within the wearable playback device 110. In some instances, the stationary playback device 1100 can include a pad portion, stand, receptacle, or other receiving portion configured to receive the wearable playback device 110 thereon to facilitate wireless charging.

In the illustrated example, the stationary playback device 1100 can obtain audio data via a network interface or line-in connection and then transmit this audio data to the wearable playback device 110 via the wireless power transmitter 220. In some instances the audio data can be encoded into the wireless power signal itself, which is recovered at the wireless power receiver 222 and then decoded. In other examples, the stationary playback device 1100 can transmit the audio data to the wearable playback device 110 via a separate wireless data connection (e.g., WiFi, Bluetooth, etc.). In either case, this allows the user to listen to audio content via their wearable playback device 110, even if the wearable playback device 110 itself does not have the capability to directly access the audio data over the one or more networks 1102.

In some examples, the wireless power device 200 can transmit data (e.g., including audio content) to the wearable audio playback device 110 (and vice versa) via the same mechanism used to transfer wireless power. For instance, the wireless power transfer signal can be used as a carrier wave, which is then modulated to encode data therein. Among examples, the carrier wave can take the form of light emitted via a laser, the AC current through an inductive coil, etc., which can then be modulated to incorporate data therein. At the receiver device, the wireless power signal can be demodulated to recover the transmitted data while also being converted to electrical energy for operation of the receiver device. In various examples, modulation of the wireless power signal to transmit data therein can include amplitude modulation, frequency modulation, phase modulation, pulse-width modulation, spread spectrum modulation, or any other suitable modulation scheme and/or combination of modulation schemes.

In at least some instances, the data transmitted via the wireless power signal can include audio content, synchronization signals, power level indicators, device identifiers, audio content metadata, power parameters, or other such data. It should be appreciated that the data to be transmitted may (or may not) be encoded according to one or more encoding schemes prior to transmission to, for example, reduce data errors in transmission (e.g., a channel encoding scheme that adds redundancy) and/or compress the data for transmission (e.g., a compression scheme that reduces the size of the data).

In some implementations, when data communication with the wearable audio playback device 110 occurs by using the wireless power transfer signal as a carrier wave, a conventional network interface (e.g., WiFi or Bluetooth antenna and associated electronics) can be omitted from the wearable audio playback device 110 altogether. This may advantageously further reduce the amount of electronic waste associated with disposing of the wearable audio playback device 110 once the device is no longer functional.

### d. Example Methods and Uses

FIG. 1200 illustrates another method 1200 for wirelessly powering a wearable audio playback device in accordance with some examples of the present technology. The method 1200 begins in block 1202 with detecting a power parameter of an audio playback device that exceeds a predetermined threshold (e.g., falling below or rising above a predetermined threshold, as appropriate). This can be, for instance, an indication that an on-board energy storage of a wearable audio playback device has fallen below a specified charge level, an indication that a power consumption rate has risen above a predetermined threshold, or any other suitable power parameter and associated threshold.

In block 1204, the method 1200 involves initiating transmission of wireless power from a wireless power device to the wearable audio playback device. For instance, the power parameter may be received at the wireless power device and then evaluated to determine whether a threshold is exceeded. In some examples, the determination can be made at the wearable audio playback device (or at another device within a media playback system) and then transmitted to the wireless power device. In response to this detection, the wireless power device can initiate wireless power transmission to the audio playback device.

The method 1200 continues in block 1206 with detecting a power parameter of audio playback returning to within a predetermined threshold. For instance, the on-board battery of the wearable audio playback device may have a charge level that exceeds its predetermined threshold, or the power consumption rate may decrease below a given threshold.

In block 1208, in response to this detection, the wireless power device ceases transmitting wireless power to the wearable audio playback device. This approach can advantageously conserve power by only transmitting wireless power when certain conditions are met (e.g., indicating that the wearable audio playback device requires power to continuously operate).

Among examples, the power parameter can characterize energy captured via an energy harvester device (e.g., total amount of energy captured over a given time, a rate of energy captured, etc.), an energy storage level of the energy storage of the wearable playback device (e.g., an energy storage percentage, an estimated time to depletion of the energy storage, etc.), energy consumed via the wearable playback device (e.g., total amount of energy consumed over a given period of time, a rate of energy consumption over a given period of time, etc.), power received via the wireless power receiver of the wearable playback device (e.g., a total amount or rate of power receipt over a given period of time), an energy storage level of one or more external devices, power consumed via one or more of the external devices, a battery age or number of charge cycles, a battery or device temperature, a device signal strength (e.g., Wi-Fi received signal strength indicator (RSSI), a zone configuration (e.g., whether devices are part of a bonded zone for audio playback, an energy zone group, etc.), or any other suitable characteristic relating to energy storage, transfer, and consumption via the wearable audio playback device.

In some examples, operation of the wireless power device and/or operation of the wearable playback device can be modified based on one or more power parameters. For instance, based on the power parameter, a controller may modify operation of the wearable audio playback device and/or of the wireless power device in order to optimize its performance and efficiency. In various implementations, modifying operation may comprise one or more of: modifying an amount or duration of wireless power transmission; modifying a selection of external devices designated for receiving wireless power; modifying audio playback (e.g., decreasing volume and/or outputting less low-frequency content when energy storage is low); disabling one or more microphones; or placing the device in an idle mode (e.g., disabling any onboard microphones, audio transducers, wireless power transfer components, or other components of the device to reduce power consumption).

In some implementations, the wearable playback device 110 can also be used to generate and playback generative media content, such as music, audio, video, or other media that is created in real-time or near real-time by one or more machine learning models (e.g., generative adversarial networks (GANs), variational autoencoders (VAEs), transformers, diffusion models, etc.).

In some examples, the user can provide input parameters to the generative model via one or more input devices integrated into the wearable playback device 110. For instance, the user might speak a prompt into an onboard microphone (e.g., “generate uplifting classical music”), provide a text prompt via a virtual keyboard or other input device, select parameters via a touchscreen, knobs, dials, or buttons (e.g., to set a tempo, key, genre, instrumentation, mood, style, etc.), or provide an image or video input (e.g., by integrated cameras disposed on the wearable playback device 110). These input parameters are then fed into the generative model, which then generates the corresponding media content. This content can either be generated at the wearable playback device 110 itself (e.g., using onboard machine learning accelerators such as neural processing units (NPUs), graphics processing units (GPUs), vision processing units (VPUs), etc.) or at a remote device (e.g., the remote servers 106 in communication with the wearable playback device 110 via the one or more networks 1102).

In various examples, the generative media content can be created using models or techniques described in one or more of the following patent applications, each of which is incorporated herein by reference in its entirety for all purposes: International Patent Application No. PCT/US2021/072454, filed Nov. 17, 2021, titled “Playback of Generative Media Content”; and International Patent Application No. PCT/US2023/074840, filed Sep. 22, 2023, titled “Generative Audio Playback via Wearable Playback Devices.”

In addition to generating and playing back the generative media content, in some instances the wearable playback device 110 can also write data to a digital ledger or blockchain (e.g., a public blockchain, private blockchain, etc.) regarding the creation, ownership, and/or playback of the generative media content by the device. For instance, the wearable playback device 110 can write transaction data to the blockchain that identifies the user of the device (e.g., using a public key, private key, crypto wallet ID, etc. associated with the user), identifies the generative media content that was created or played back, indicates a number of times or frequency of playback, identifies any input parameters provided by the user, identifies any user reactions to the content (e.g., as determined by onboard biometric sensors such as heart rate sensors, EEG sensors, etc.), or any other suitable data regarding the generative media content. In some instances, the wearable playback device 110 can also access or query data from the blockchain (e.g., from other users' devices) to determine, for example, the popularity, quality, etc. of a given generative media content item or model. This data can then be used locally at the wearable playback device 110 to determine which generative media content to produce or playback to the user. In various examples, the wearable playback device can utilize or generate blockchain data using any of the techniques described in International Patent Application No. PCT/US2023/066776, filed May 9, 2023, titled “Generating Digital Media Based on Blockchain Data,” which is hereby incorporated by reference in its entirety for all purposes.

In the illustrated examples described above, the devices (e.g., playback device 110 or wireless power device 200) may be shown as audio playback devices or other particular devices. In various examples, however, one or more of the devices may comprise other types of devices including smartphones, tablets, video display devices (e.g., televisions), internet of things (IoT) devices such as sensors, cameras, microphones, thermostats, light sources, smart doorbells, etc. Additionally, while various examples relate to wearable devices, in some implementations the audio playback device 110 and/or the wireless power device 200 may be non-wearable (e.g., stationary or portable devices not configured to be worn by a user). In further implementations, the technology described herein can be applied to devices 110 that are configured to be implanted, whether or not the devices take the form of audio playback devices.

### VI. Conclusion

The above discussions relating to wireless power transfer devices, playback devices, controller devices, playback zone configurations, and media/audio content sources provide only some examples of operating environments within which functions and methods described below may be implemented. Other operating environments and configurations of wireless power transfer systems, media playback systems, playback devices, and network devices not explicitly described herein may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways) to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the foregoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

The present technology is illustrated, for example, according to various aspects described below. Various examples of aspects of the present technology are described as numbered examples for convenience. These are provided as examples and do not limit the present technology. It is noted that any of the dependent examples may be combined in any combination, and placed into a respective independent example. The other examples can be presented in a similar manner.

Example 1: A system comprising: a wearable playback device configured to be worn over an ear of a user, the wearable playback device comprising: a first earcup carrying a first audio transducer and a second earcup carrying a second audio transducer, the first earcup and the second earcup coupled together via a headband; an ear cushion configured to be removably coupled to the first earcup; and a wireless power receiver disposed within the ear cushion, the wireless power receiver configured to supply electrical energy for operation of the first audio transducer; and a wireless charging device configured to supply energy to the wearable playback device, the wireless charging device comprising: an energy storage component; and a wireless power transmitter configured to wirelessly supply energy to the wireless power receiver.

Example 2. The system of any preceding Example, wherein the wireless power receiver comprises a conductive coil.

Example 3. The system of any preceding Example, wherein the conductive coil defines a central aperture that is aligned with a primary acoustic axis of the first audio transducer.

Example 4. The system of any preceding Example, wherein the ear cushion comprises an annular padding member defining a central aperture and a barrier member spanning across the central aperture, and wherein the wireless power receiver is carried by the barrier member.

Example 5. The system of any preceding Example, wherein the barrier member comprises a fabric material, and wherein the wireless power receiver comprises a coil embedded within and/or woven into the fabric material.

Example 6. The system of any preceding Example, wherein the ear cushion comprises an annular padding member having a conductive material disposed therein.

Example 7. The system of any preceding Example, wherein the wireless power receiver is electrically coupled to the first earcup via a wired connection.

Example 8. The system of any preceding Example, wherein the wireless power receiver comprises first electrical contacts disposed on an inner side of the ear cushion, the first earcup comprises second electrical contacts disposed on an outer side of the first earcup, and when the ear cushion is coupled to the first earcup, the first electrical contacts and the second electrical contacts are connected, thereby electrically coupling the wireless power receiver and electronics disposed within the first earcup.

Example 9. The system of any preceding Example, wherein the first earcup and the ear cushion each comprise magnetic elements to facilitate alignment of the first electrical contacts and the second electrical contacts when the ear cushion and the first earcup are coupled together.

Example 10. The system of any preceding Example, wherein the wireless charging device comprises a case configured to receive the wearable playback device therein, the case comprising alignment features such that when the wearable playback device is disposed therein, the wireless power receiver is aligned with the wireless power transmitter disposed within the case.

Example 11. The system of any preceding Example, wherein the wireless charging device comprises a stand configured to receive the wearable playback device thereon.

Example 12. The system of any preceding Example, wherein the wireless power transmitter is configured to supply electrical energy to the wireless power receiver via one or more of: electromagnetic induction, magnetic resonance, or capacitive coupling.

Example 13. The system of any preceding Example, wherein the energy storage component of the wireless charging device comprises a first energy storage component, and wherein the wearable playback device comprises a second energy storage component having a lower energy storage capacity than the first energy storage component, and wherein the wireless power receiver disposed within the ear cushion is configured to recharge to the second energy storage component.

Example 14. A wearable playback device comprising: a first earcup carrying a first audio transducer; a second earcup carrying a second audio transducer; a headband coupling the first earcup and the second earcup; an ear cushion configured to be removably coupled to the first earcup; and a wireless power receiver disposed within the ear cushion, the wireless power receiver configured to (i) receive electrical energy from an external wireless power transmitter device, and (ii) supply electrical energy for operation of the first audio transducer.

Example 15. The wearable playback device of any preceding Example, wherein the wireless power receiver comprises a conductive coil.

Example 16. The wearable playback device of any preceding Example, wherein the conductive coil defines a central aperture that is aligned with a primary acoustic axis of the first audio transducer.

Example 17. The wearable playback device of any preceding Example, wherein the ear cushion comprises an annular padding member defining a central aperture and a barrier member spanning across the central aperture, and wherein the wireless power receiver is carried by the barrier member.

Example 18. The wearable playback device of any preceding Example, wherein the barrier member comprises a fabric material, and wherein the wireless power receiver comprises a coil embedded within and/or woven into the fabric material.

Example 19. The wearable playback device of any preceding Example, wherein the ear cushion comprises an annular padding member having a conductive material disposed therein.

Example 20. The wearable playback device of any preceding Example, wherein the wireless power receiver is electrically coupled to the first earcup via a wired connection.

Example 21. The wearable playback device of any preceding Example, wherein the wireless power receiver comprises first electrical contacts disposed on an inner side of the ear cushion, the first earcup comprises second electrical contacts disposed on an outer side of the first earcup, and when the ear cushion is coupled to the first earcup, the first electrical contacts and the second electrical contacts are connected, thereby electrically coupling the wireless power receiver and electronics disposed within the first earcup.

Example 22. The wearable playback device of any preceding Example, wherein the first earcup and the ear cushion each comprise magnetic elements to facilitate alignment of the first electrical contacts and the second electrical contacts when the ear cushion and the first earcup are coupled together.

Example 23. A system comprising: a wearable device configured to be worn over an ear of a user, the wearable playback device comprising: a first earcup carrying a first audio transducer and a second earcup carrying a second audio transducer, the first earcup and the second earcup coupled together via a headband; a wireless power receiver disposed within the headband, the wireless power receiver configured to supply electrical energy to at least one of the first earcup or the second earcup; and a wireless charging device configured to supply energy to the wearable playback device, the wireless charging device comprising: an energy storage component; and a wireless power transmitter configured to wirelessly supply energy to the wireless power receiver.

Example 24. The system of any preceding Example, wherein the wireless power receiver comprises a conductive coil.

Example 25. The system of any preceding Example, wherein the wireless charging device comprises a case configured to receive the wearable playback device therein, the case comprising alignment features such that when the wearable playback device is disposed therein, the wireless power receiver is aligned with the wireless power transmitter disposed within the case.

Example 26. The system of any preceding Example, wherein the wireless charging device comprises a stand comprising a support portion configured to receive the headband of the wearable playback device thereon, and wherein the wireless power transmitter is disposed within the support portion such that the wireless power transmitter is aligned with the wireless power receiver when the wearable device is disposed on the stand.

Example 27. The system of any preceding Example, wherein the wireless power transmitter is configured to supply electrical energy to the wireless power receiver via one or more of: electromagnetic induction, magnetic resonance, or capacitive coupling.

Example 28. The system of any preceding Example, wherein the energy storage component of the wireless charging device comprises a first energy storage component, and wherein the wearable playback device comprises a second energy storage component having a lower energy storage capacity than the first energy storage component, and wherein the wireless power receiver disposed within the headband is configured to recharge to the second energy storage component.

Example 29. A wearable audio playback device comprising: a first earcup carrying a first audio transducer, the first earcup comprising: electrical contacts disposed on an outer side of the first earcup, the electrical contacts configured to be electrically coupled to corresponding electrical contacts of an ear cushion having a wireless power transfer received therein, thereby electrically coupling the wireless power receiver and electronics disposed within the first earcup; a second earcup carrying a second audio transducer; and a headband coupling the first earcup and the second earcup.

Example 30. The wearable playback device of any preceding Example, wherein the first earcup and the ear cushion each comprise magnetic elements to facilitate alignment of the first electrical contacts and the second electrical contacts when the ear cushion and the first earcup are coupled together.

1. A system comprising:
a wearable playback device configured to be worn over an ear of a user, the wearable playback device comprising:
a first earcup carrying a first audio transducer and a second earcup carrying a second audio transducer, the first earcup and the second earcup coupled together via a headband;
an ear cushion configured to be removably coupled to the first earcup; and
a wireless power receiver disposed within the ear cushion, the wireless power receiver configured to supply electrical energy for operation of the first audio transducer; and
a wireless charging device configured to supply energy to the wearable playback device, the wireless charging device comprising:
an energy storage component; and
a wireless power transmitter configured to wirelessly supply energy to the wireless power receiver.

2. The system of claim 1, wherein the wireless power receiver comprises a conductive coil.

3. The system of claim 2, wherein the conductive coil defines a central aperture that is aligned with a primary acoustic axis of the first audio transducer.

4. The system of claim 1, wherein the ear cushion comprises an annular padding member defining a central aperture and a barrier member spanning across the central aperture, and wherein the wireless power receiver is carried by the barrier member.

5. The system of claim 4, wherein the barrier member comprises a fabric material, and wherein the wireless power receiver comprises a coil embedded within and/or woven into the fabric material.

6. The system of claim 1, wherein the ear cushion comprises an annular padding member having a conductive material disposed therein.

7. The system of claim 1, wherein the wireless power receiver is electrically coupled to the first earcup via a wired connection.

8. The system of claim 1, wherein the wireless power receiver comprises first electrical contacts disposed on an inner side of the ear cushion, the first earcup comprises second electrical contacts disposed on an outer side of the first earcup, and when the ear cushion is coupled to the first earcup, the first electrical contacts and the second electrical contacts are connected, thereby electrically coupling the wireless power receiver and electronics disposed within the first earcup.

9. The system of claim 8, wherein the first earcup and the ear cushion each comprise magnetic elements to facilitate alignment of the first electrical contacts and the second electrical contacts when the ear cushion and the first earcup are coupled together.

10. The system of claim 1, wherein the wireless charging device comprises a case configured to receive the wearable playback device therein, the case comprising alignment features such that when the wearable playback device is disposed therein, the wireless power receiver is aligned with the wireless power transmitter disposed within the case.

11. The system of claim 1, wherein the wireless charging device comprises a stand configured to receive the wearable playback device thereon.

12. The system of claim 1, wherein the energy storage component of the wireless charging device comprises a first energy storage component, and wherein the wearable playback device comprises a second energy storage component having a lower energy storage capacity than the first energy storage component, and wherein the wireless power receiver disposed within the ear cushion is configured to recharge to the second energy storage component.

13. A wearable playback device comprising:
a first earcup carrying a first audio transducer;
a second earcup carrying a second audio transducer;
a headband coupling the first earcup and the second earcup;
an ear cushion configured to be removably coupled to the first earcup; and
a wireless power receiver disposed within the ear cushion, the wireless power receiver configured to (i) receive electrical energy from an external wireless power transmitter device, and (ii) supply electrical energy for operation of the first audio transducer.

14. The wearable playback device of claim 13, wherein the wireless power receiver comprises a conductive coil defining a central aperture that is aligned with a primary acoustic axis of the first audio transducer.

15. The wearable playback device of claim 13, wherein the ear cushion comprises an annular padding member defining a central aperture and a barrier member spanning across the central aperture, and wherein the wireless power receiver is carried by the barrier member.

16. The wearable playback device of claim 13, wherein the wireless power receiver is electrically coupled to the first earcup via a wired connection.

17. A system comprising:
a wearable playback device configured to be worn over an ear of a user, the wearable playback device comprising:
a first earcup carrying a first audio transducer and a second earcup carrying a second audio transducer, the first earcup and the second earcup coupled together via a headband;
a wireless power receiver disposed within the headband, the wireless power receiver configured to supply electrical energy to at least one of the first earcup or the second earcup; and
a wireless charging device configured to supply energy to the wearable playback device, the wireless charging device comprising:
an energy storage component; and
a wireless power transmitter configured to wirelessly supply energy to the wireless power receiver.

18. The system of claim 17, wherein the wireless charging device comprises a case configured to receive the wearable playback device therein, the case comprising alignment features such that when the wearable playback device is disposed therein, the wireless power receiver is aligned with the wireless power transmitter disposed within the case.

19. The system of claim 17, wherein the wireless charging device comprises a stand comprising a support portion configured to receive the headband of the wearable playback device thereon, and wherein the wireless power transmitter is disposed within the support portion such that the wireless power transmitter is aligned with the wireless power receiver when the wearable playback device is disposed on the stand.

20. The system of claim 17, wherein the energy storage component of the wireless charging device comprises a first energy storage component, and wherein the wearable playback device comprises a second energy storage component having a lower energy storage capacity than the first energy storage component, and wherein the wireless power receiver disposed within the headband is configured to recharge to the second energy storage component.
